(19) United States
(12) Patent Application Publication
(10) Pub. No.: US 2023/0021061 A1
(43) Pub. Date: Jan. 19, 2023

(54) COMPUTER-READABLE RECORDING MEDIUM STORING CONTRACT PROGRAM, CONTRACT METHOD, AND INFORMATION PROCESSING APPARATUS

(71) Applicant: FUJITSU LIMITED, Kawasaki-shi (JP)

(72) Inventors: Toshihiro Shimizu, Kawasaki (JP); Akihito Nakamura, Shinagawa (JP); Akihiro Kuwabara, Meguro (JP); Motohiro KOSAKI, Kawasaki (JP)

(73) Assignee: FUJITSU LIMITED, Kawasaki-shi (JP)

(21) Appl. No.: 17/719,423

(22) Filed: Apr. 13, 2022

(30) Foreign Application Priority Data
Jul. 7, 2021 (JP) 2021-112910

(51) Int. Cl. G06Q 40/04

(52) U.S. Cl. CPC G06Q 40/04

(57) ABSTRACT

A non-transitory computer-readable recording medium stores a contract program causing a computer to execute a process including: setting, for accepted sell order and buy order, information based on the accepted sell order and buy order to an element of one array specified by counting an order count of one order of the sell order and the buy order as a plus, and counting an order count of the other order of the sell order and the buy order as a minus; and specifying an order to be a contract target among the accepted sell order and buy order, based on the information set in the one array.

### CROSS-REFERENCE TO RELATED APPLICATION

This application is based upon and claims the benefit of priority of the prior Japanese Patent Application No. 2021-112910, filed on Jul. 7, 2021, the entire contents of which are incorporated herein by reference.

### FIELD

The embodiments discussed herein are related to a non-transitory computer-readable recording medium storing a contract program, a contract method, and an information processing apparatus.

### BACKGROUND

In a securities market, establishment of trading such as stock trading is called a “contract”. For example, a state in which conditions of a user who makes a sell order and a user who makes a buy order are matched and trading is established is referred to as a contract. In a case where a user makes an order (a sell order or a buy order), the user may make the order under a condition that a contract of a total amount is made or a contract of a certain order count is made.

Japanese Laid-open Patent Publication No. 2019-91388 and U.S. Patent No. 2018/0260898 are disclosed as related art.

### SUMMARY

According to an aspect of the embodiments, a non-transitory computer-readable recording medium stores a contract program causing a computer to execute a process including: setting, for accepted sell order and buy order, information based on the accepted sell order and buy order to an element of one array specified by counting an order count of one order of the sell order and the buy order as a plus, and counting an order count of the other order of the sell order and the buy order as a minus; and specifying an order to be a contract target among the accepted sell order and buy order, based on the information set in the one array.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram (1) describing a process on a first array a in a case where a sell order is accepted;

FIG. 2 is a diagram illustrating an example of a second array a in a case where a buy order is accepted;

FIG. 3 is a diagram illustrating an example of a process of calculating a contract count according to Embodiment 1;

FIG. 4 is a diagram (2) describing a process on the first array a in a case where a sell order is accepted;

FIG. 5 is a diagram (1) describing a process of specifying an order to be a contract target according to Embodiment 1;

FIG. 6 is a diagram (2) describing the process of specifying the order to be the contract target according to Embodiment 1;

FIG. 7 is a diagram illustrating a configuration of an information processing apparatus according to Embodiment 1;

FIG. 8 is a diagram illustrating an example of a data structure of a sell order table according to Embodiment 1;

FIG. 9 is a diagram illustrating an example of a data structure of a buy order table according to Embodiment 1;

FIG. 10 is a diagram illustrating an example of a data structure of first array information according to Embodiment 1;

FIG. 11 is a diagram illustrating an example of a data structure of second array information according to Embodiment 1;

FIG. 12 is a diagram illustrating an example of a data structure of contract result information according to Embodiment 1;

FIG. 13 is a flowchart illustrating a processing procedure of the information processing apparatus according to Embodiment 1;

FIG. 14 is a flowchart illustrating a processing procedure of an order specifying process according to Embodiment 1;

FIG. 15 is a flowchart illustrating a processing procedure of a setting process in a case where a minimum contract count is guaranteed;

FIG. 16 is a diagram (1) describing the setting process in a case where the minimum contract count is guaranteed;

FIG. 17 is a diagram (2) describing the setting process in the case where the minimum contract count is guaranteed;

FIG. 18 is a diagram (3) describing the setting process in the case where the minimum contract count is guaranteed;

FIG. 19 is a diagram (4) describing the setting process in the case where the minimum contract count is guaranteed;

FIG. 20 is a diagram illustrating an example of matching between a sell order and a buy order related to a total amount contract order for which a price is designated;

FIG. 21 is a diagram (1) describing a process on the array a in a case where a sell order is accepted;

FIG. 22 is a diagram (2) describing the process on the array a in a case where a sell order is accepted;

FIG. 23 is a diagram describing a process on an array b in a case where a buy order is accepted;

FIG. 24 is a diagram describing an example of a process of calculating a contract count according to Embodiment 2;

FIG. 25 is a diagram (3) describing the process on the array a in a case where the sell order is accepted;

FIG. 26 is a diagram describing a process of specifying an order to be a contract target according to Embodiment 2;

FIG. 27 is a diagram illustrating an example of a configuration of an information processing apparatus according to Embodiment 2;

FIG. 28 is a diagram illustrating an example of a data structure of a sell order table according to Embodiment 2;

FIG. 29 is a diagram illustrating an example of a data structure of a buy order table according to Embodiment 2;

FIG. 30 is a diagram illustrating an example of a data structure of first array information according to Embodiment 2;

FIG. 31 is a diagram illustrating an example of a data structure of second array information according to Embodiment 2;

FIG. 32 is a diagram illustrating an example of a data structure of contract result information according to Embodiment 2;

FIG. 33 is a flowchart illustrating a processing procedure of the information processing apparatus according to Embodiment 2;

FIG. 34 is a flowchart illustrating a processing procedure of an array update process on a sell order according to Embodiment 2;

FIG. 35 is a flowchart illustrating a processing procedure of an array update process on a buy order according to Embodiment 2;

FIG. 36 is a diagram illustrating an example of a data structure of array information according to Embodiment 3;

FIG. 37 is a diagram describing a process on an array according to Embodiment 3;

FIG. 38 is an explanatory diagram describing compression of indices;

FIG. 39 is a diagram illustrating an example of a hardware configuration of a computer that implements a function in the same manner as a function of the information processing apparatus according to the embodiment; and

FIG. 40 is a diagram illustrating an example of matching between a sell order and a buy order in which a minimum contract count is set.

### DESCRIPTION OF EMBODIMENTS

In the following description, a minimum limit contract count, which is a condition set for an order, is referred to as a “minimum contract count”. For example, in a case where there is a sell order having an order count “N” with a condition of a minimum contract count “M”, and in a case where there is a buy order having an order count equal to or greater than the order count “M”, trading is established.

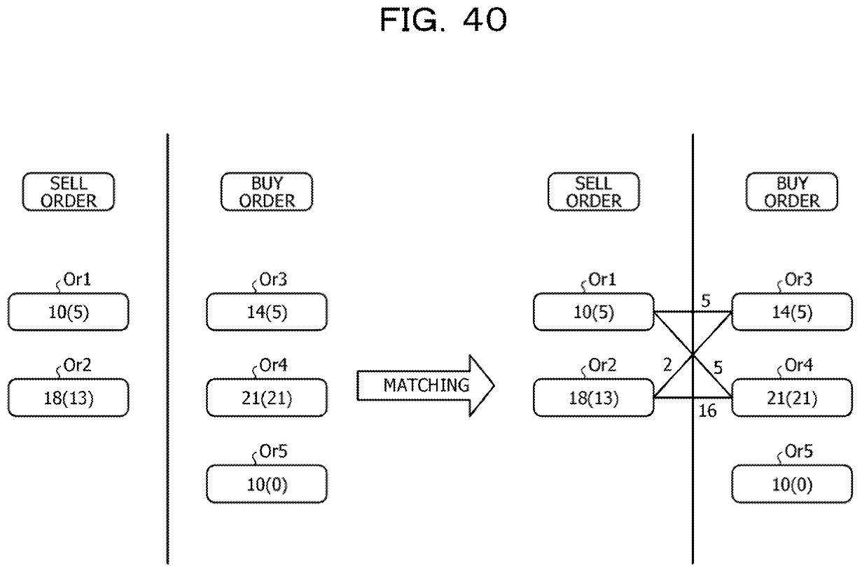

FIG. 40 is a diagram illustrating an example of matching between a sell order and a buy order in which a minimum contract count is set. In the example illustrated in FIG. 40, orders Or1 and Or2 exist as sell orders. The order Or1 is an order in which an order count is “10” and a minimum contract count is “5”. The order Or2 is an order in which an order count is “18” and a minimum contract count is “13”.

Orders Or3, Or4, and Or5 exist as buy orders. The order Or3 is an order in which an order count is “14” and a minimum contract count is “5”. The order Or4 is an order in which an order count is “21” and a minimum contract count is “21”. The order Or5 is an order in which an order count is “10” and a minimum contract count is “0”.

According to the conditions of the sell orders and the buy orders illustrated in FIG. 40, in a case where a contract count is maximized, a matching result is as follows. For example, a contract of an order count “5” is made with the order Or1 and the order Or3, and a contract of an order count “5” is made with the order Or1 and the order Or4. A contract of an order count “2” is made with the order Or2 and the order Or3, and a contract of an order count “16” is made with the order Or2 and the order Or4.

Meanwhile, in the related art described above, since order statuses of the sell order and the buy order of contract targets are separately handled, there is a problem that a large calculation cost is desirable for matching the contracts.

According to one aspect, an object is to provide a non-transitory computer-readable recording medium storing a contract program, a contract method, and an information processing apparatus capable of reducing a calculation cost when obtaining a contract of trading.

Hereinafter, a non-transitory computer-readable recording medium storing a contract program, a contract method, and an information processing apparatus according to embodiments will be described below with reference to the drawings. In the embodiments, components having the same functions will be denoted by the same reference signs, and redundant description thereof will be omitted. The non-transitory computer-readable recording medium storing the contract program, the contract method, and the information processing apparatus to be described in the embodiments below are merely examples, and are not intended to limit the embodiment. Each embodiment below may be appropriately combined to the degree with which no inconsistency is caused.

### Embodiment 1

In an information processing apparatus according to Embodiment 1, a Bool (T, F) array a is prepared for managing each of the sell order and the buy order, and an order as a contract target that maximizes a contract count is specified.

The Bool (T, F) array a is referred to as an “array a”. An index i equal to or greater than 0 is set for the array a, and “T” or “F” is set for an element corresponding to the index i of the array a. A case where the element corresponding to the index i in the array a is “T” means that there is an order of an order count i. A case where the element corresponding to the index i in the array a is “F” means that there is no order of the order count i. “T” is an example of a registration symbol.

The case where the element of the index i in the array a is “T” is indicated by a[i]=T. The case where the element of the index i in the array a is “F” is indicated by a[i]=F.

In Embodiment 1, an array a for storing information on a sell order is referred to as a “first array a”, and an array a for storing information on a buy order is referred to as a “second array a”.

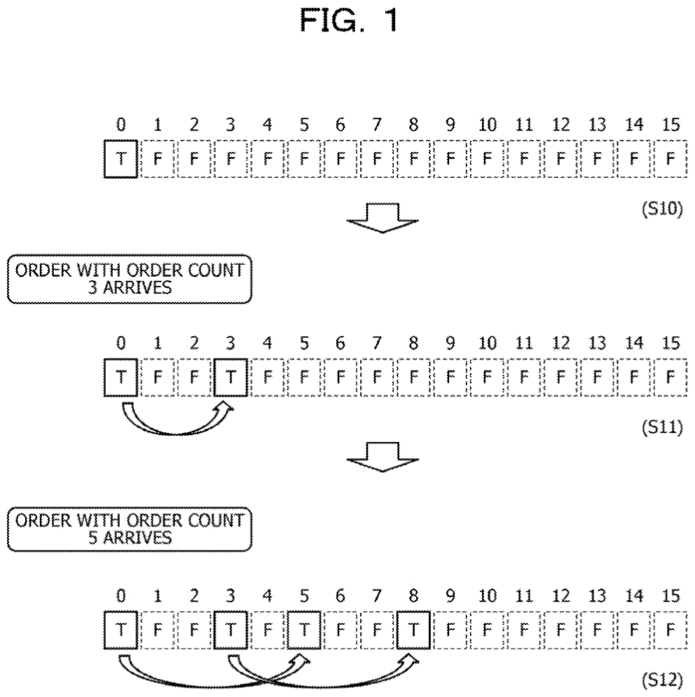

First, a process in which the information processing apparatus according to Embodiment 1 calculates a maximum matchable contract count will be described. FIG. 1 is a diagram describing a process on the first array a in a case where a sell order is accepted. The information processing apparatus sets a[i+x]=T in a case where a[i]=T and a sell order of an order count x is accepted.

An initial state of the first array a is illustrated in step S10. In the initial state of the first array a, a[0]=T, and all other elements are “F”.

In a case where a sell order having an order count 3 is accepted, a state of the first array a is as illustrated in step S11. Since the first array a is a[0]=T, the information processing apparatus sets a[0+3]=T.

In a case where an order having an order count 5 is accepted, the state of the first array a is as illustrated in step S12. Since the first array a is a[0]=T, the information processing apparatus sets a[0+5]=T. Since the first array a is a[3]=T, the information processing apparatus sets a[3+5]=T.

An index in which an element of the first array a is T indicates a matchable contract quantity. For example, in the state of the first array a in step S12 in FIG. 1, the element of the index i=8 is “T”, and “8” is a quantity for which contracts of a total amount of the order count “3” and the order count “5” are made.

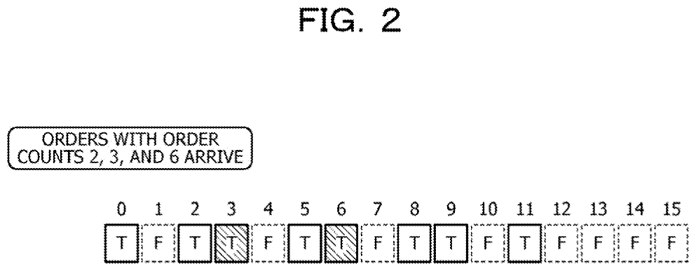

FIG. 2 is a diagram illustrating an example of the second array a in a case where a buy order is accepted. In the same manner as the process for the first array a in a case where the sell order is accepted described with reference to FIG. 1, the information processing apparatus sets a[i+x]=T in a case where a[i]=T and a buy order of the order count x is accepted. In an initial state of the second array a, a[0]=T, and all other elements are “F”.

For example, in a case where a buy order having an order count 2, a buy order having an order count 3, and a buy order having an order count 6 are accepted in this order, the state of the second array a is as illustrated in FIG. 2. For example, a[0]=T, a[2]=T, a[3]=T, a[5]=T, a[6]=T, a[8]=T, a[9]=T, and a[11]=T, and the other elements are “F”.

The information processing apparatus compares the first array a of the sell orders described with reference to FIG. 1 and the second array a described with reference to FIG. 2, and specifies a maximum matchable contract quantity.

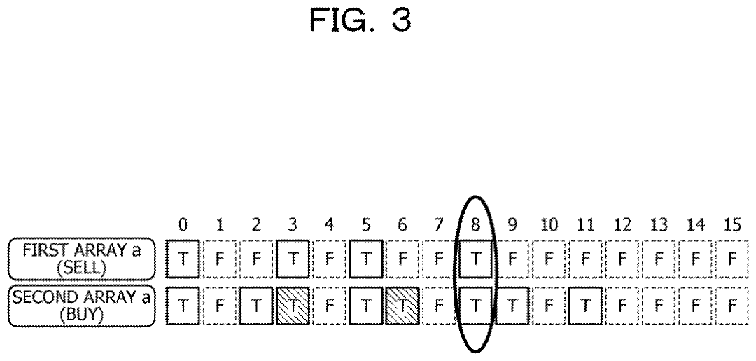

FIG. 3 is a diagram illustrating an example of a process of calculating a contract count according to Embodiment 1. The information processing apparatus compares the first array a with the second array a, and specifies a largest index among indices in which both of an element of the first array a and an element of the second array a are “T”, as a maximum contract count. In the example illustrated in FIG. 3, since the largest index among the indices in which both of the element of the first array a and the element of the second array a are “T” is “8”, the information processing apparatus calculates the maximum matchable contract quantity as “8”.

Next, a process in which the information processing apparatus according to Embodiment 1 specifies an order to be a contract target will be described. In a case of accepting an order and setting “T” in an element of the array a for the first time, the information processing apparatus registers auxiliary information indicating an order reception sequence (order sequence) and a quantity (order count) for each index, and thus it is possible to specify an order as a contract target.

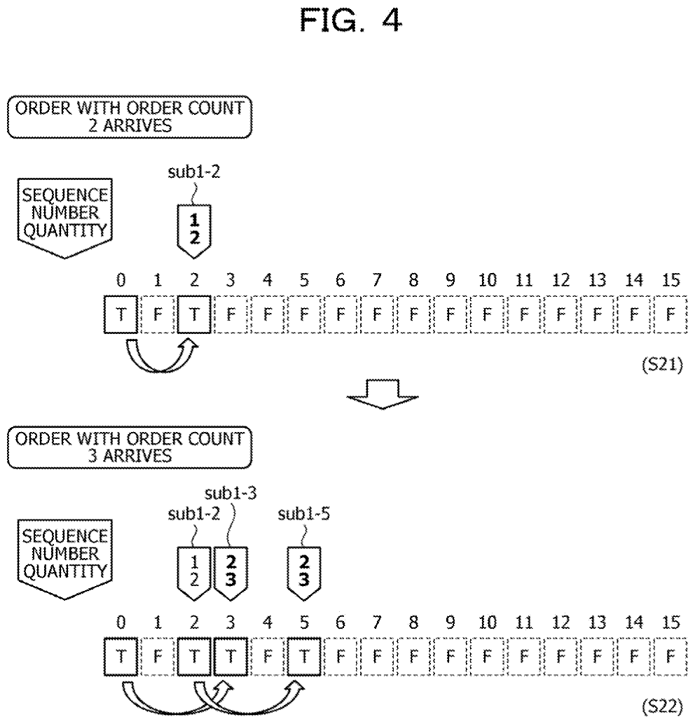

FIG. 4 is a diagram (2) describing a process on the first array a in a case where the sell order is accepted. Although an initial state of the first array a is not illustrated in FIG. 4, the initial state of the first array a corresponds to the state of the first array a in step S10 described with reference to FIG. 1. The information processing apparatus does not give auxiliary information to an element of “T” in the initial state. An order reception sequence of the sell order corresponds to a “first order sequence”, and an order count of the sell order corresponds to a “first order count”.

First (order reception sequence=1), in a case where a sell order having an order count 2 is accepted, a state of the first array a is as illustrated in step S21. Since the first array a in the initial state is a[0]=T, the information processing apparatus sets a[0+2]=T. Auxiliary information sub1−2 is registered at the index i=2. A sequence number “1” and a quantity “2” are set in the auxiliary information sub1−2.

Next (order reception sequence=2), in a case where a sell order having an order count 3 is accepted, the state of the first array a is as illustrated in step S22. Since the first array a is a[0]=T, the information processing apparatus sets a[0+3]=T, and registers auxiliary information sub1−3 to the index i=3. A sequence number “2” and a quantity “3” are set in the auxiliary information sub1−3.

Since the first array a is a[2]=T, the information processing apparatus sets a[2+3]=T, and registers auxiliary information sub1−5 to the index i=5. A sequence number “2” and a quantity “3” are set in the auxiliary information sub1−5.

Although not illustrated, also in a case where a buy order is accepted, the information processing apparatus sets “T” in an element of the second array a, and registers auxiliary information in an index in the same manner as in FIG. 4. An order reception sequence of the buy order corresponds to a “second order sequence”, and an order count of the buy order corresponds to a “second order count”.

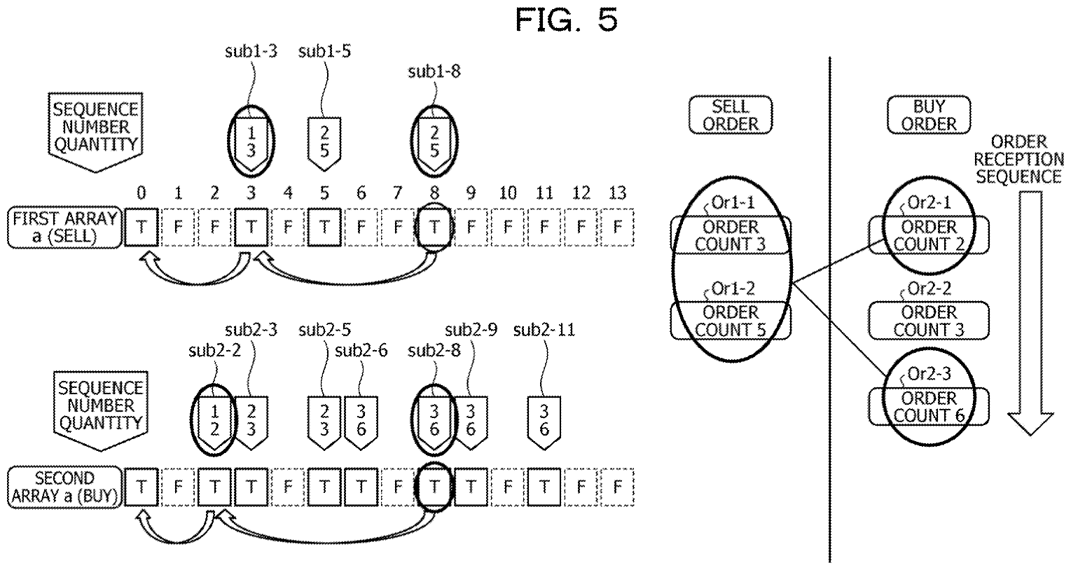

FIG. 5 is a diagram (1) describing a process of specifying an order to be a contract target according to Embodiment 1. As illustrated in FIG. 5, the information processing apparatus sequentially accepts orders Or1-1 and Or1-2 as sell orders. The order Or1-1 is an order having an order count “3”. The order Or1-2 is an order having an order count “5”. The information processing apparatus sequentially accepts orders Or2-1, Or2-2, and Or2-3 as buy orders. The order Or2-1 is an order having an order count “2”. The order Or2-2 is an order having an order count “3”. The order Or2-3 is an order having an order count “6”.

After accepting the orders Or1-1 and Or1-2 in order, the information processing apparatus executes the process on the first array a in a case where the sell order is accepted so as to set the first array a to the state as illustrated in FIG. 5. An element of the index i=0, 3, 5, and 8 of the first array a is “T”, and the other elements are “F”. “T” of the index i=0 is set in an initial state.

The information processing apparatus sets the auxiliary information sub1−3 to the index i=3 in the first array a. A sequence number “1” and a quantity “3” are set in the auxiliary information sub1−3. The information processing apparatus sets auxiliary information sub1−5 to the index i=5 in the first array a. A sequence number “2” and a quantity “5” are set in the auxiliary information sub1−5. The information processing apparatus sets auxiliary information sub1−8 to the index i=8 in the first array a. A sequence number “2” and a quantity “5” are set in the auxiliary information sub1−8.

After accepting the orders Or2-1, Or2-2, and Or2-3 in order, the information processing apparatus executes a process on the second array a in a case where the buy order is accepted so as to set the second array a to the state as illustrated in FIG. 5. An element of the index i=0, 2, 3, 5, 6, 8, 9, and 11 in the second array a is “T”, and the other elements are “F”. “T” of the index i=0 is set in an initial state.

The information processing apparatus sets auxiliary information sub2−2 to the index i=2 in the second array a. A sequence number “1” and a quantity “2” are set in the auxiliary information sub2−2. The information processing apparatus sets auxiliary information sub2−3 to the index i=3 in the second array a. A sequence number “2” and a quantity “3” are set in the auxiliary information sub2−3. The information processing apparatus sets auxiliary information sub2−5 to the index i=5 in the second array a. A sequence number “2” and a quantity “3” are set in the auxiliary information sub2−5.

The information processing apparatus sets auxiliary information sub2−6 to the index i=6 in the second array a. A sequence number “3” and a quantity “6” are set in the auxiliary information sub2−6. The information processing apparatus sets auxiliary information sub2−8 to the index i=8 in the second array a. A sequence number “3” and a quantity “6” are set in the auxiliary information sub2−8. The information processing apparatus sets auxiliary information sub2−9 to the index i=9 in the second array a. A sequence number “3” and a quantity “6” are set in the auxiliary information sub2−9. The information processing apparatus sets auxiliary information sub2−11 to the index i=11 in the second array a. A sequence number “3” and a quantity “6” are set in the auxiliary information sub2−11.

The information processing apparatus compares the first array a with the second array a, and calculates a largest index among indices in which both of an element of the first array a and an element of the second array a are “T”, as a contract count. According to the example illustrated in FIG. 5, the largest index among the indices in which both the element of the first array a and the element of the second array a are “T” is the index i=8. For this reason, the information processing apparatus sets the contract count to “8”.

After calculating the contract count, the information processing apparatus specifies an order as a contract target, based on the auxiliary information set in the array a. In a case of a contract with a contract count i₀, the information processing apparatus sets an initial value of the index i=i₀, and repeatedly executes the following process until i=0.

A process repeated by the information processing apparatus is the following process. The information processing apparatus treats an order with a[i]=T as a contract target. Next, the information processing apparatus specifies a quantity α included in the auxiliary information set in a[i], and updates the index i by i=i−α.

Based on the “first array a” in FIG. 5, a process in which the information processing apparatus specifies a sell order for a contract will be described.

The information processing apparatus treats, as a contract target, an order corresponding to the auxiliary information sub1−8 set to the index i=8 corresponding to the contract count “8”. The auxiliary information sub1−8 corresponds to the order Or1-2 with the sequence number “2” and the quantity “5”. The information processing apparatus acquires the quantity α=5 included in the auxiliary information sub1−8, and updates the index i=8−5=3.

The information processing apparatus treats an order corresponding to the auxiliary information sub1−3 set to the index i=3 as a contract target. The auxiliary information 1-3 corresponds to the order Or1-1 with the sequence number “1” and the quantity “3”. The information processing apparatus acquires the quantity α=3 included in the auxiliary information sub1−3, and updates the index i=3−3=0. Since the index i=0, the information processing apparatus ends the process.

Based on the “second array a” in FIG. 5, a process in which the information processing apparatus specifies a buy order for a contract will be described.

The information processing apparatus treats, as a contract target, an order corresponding to the auxiliary information sub2−8 set to the index i=8 corresponding to the contract count “8”. The auxiliary information 2-8 corresponds to the order Or2-3 with the sequence number “3” and the quantity “6”. The information processing apparatus acquires the quantity α=6 included in the auxiliary information sub2−8, and updates the index i=8−6=2.

The information processing apparatus treats an order corresponding to the auxiliary information sub2−2 set to index i=2 as a contract target. The auxiliary information sub2−2 corresponds to the order Or2-1 with the sequence number “1” and the quantity “2”. The information processing apparatus acquires the quantity α=2 included in the auxiliary information sub2−2, and updates the index i=2−2=0. Since the index i=0, the information processing apparatus ends the process.

With the above-described process, the sell orders Or1-1 and Or1-2 and the buy orders Or2-1 and Or2-3 are specified as the contract targets.

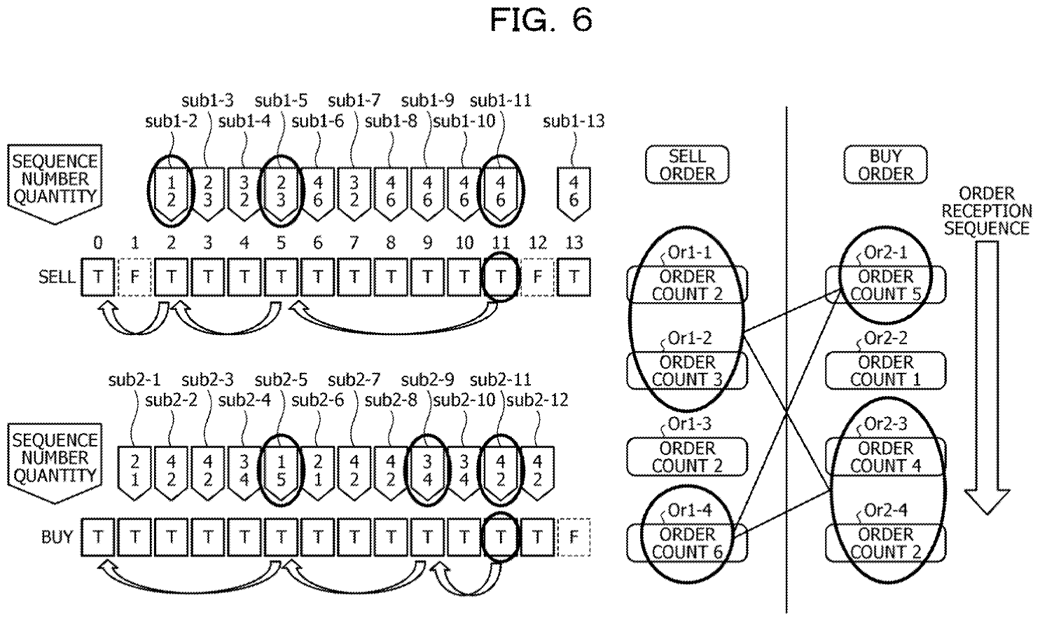

FIG. 6 is a diagram (2) describing the process of specifying the order to be the contract target according to Embodiment 1. In FIG. 6, the information processing apparatus sequentially accepts orders Or1-1, Or1-2, Or1-3, and Or1-4 as sell orders. The order Or1-1 is an order having an order count “2”. The order Or1-2 is an order having an order count “3”. The order Or1-3 is an order having an order count “2”. The order Or1-4 is an order having an order count “6”.

The information processing apparatus sequentially accepts orders Or2-1, Or2-2, Or2-3, and Or2-4 as buy orders. The order Or2-1 is an order having an order count “5”. The order Or2-2 is an order having an order count “1”. The order Or2-3 is an order having an order count “4”. The order Or2-4 is an order having an order count “2”.

After accepting the orders Or1-1, Or1-2, Or1-3, and Or1-4 in order, the information processing apparatus executes a process on the first array a in a case where the buy order is accepted so as to set the first array a to the state as illustrated in FIG. 6. An element of the index i=0, 2 to 11, and 13 of the first array a is “T”, and the other elements are “F”. “T” of the index i=0 is set in an initial state.

The information processing apparatus sets the auxiliary information sub1−2 to the index i=2 in the first array a. A sequence number “1” and a quantity “2” are set in the auxiliary information sub1−2. The information processing apparatus sets the auxiliary information sub1−3 to the index i=3 in the first array a. A sequence number “2” and a quantity “3” are set in the auxiliary information sub1−3. The information processing apparatus sets auxiliary information sub1−4 to the index i=4 in the first array a. A sequence number “3” and a quantity “2” are set in the auxiliary information sub1−4.

The information processing apparatus sets auxiliary information sub1−5 to the index i=5 in the first array a. A sequence number “2” and a quantity “3” are set in the auxiliary information sub1−5. The information processing apparatus sets auxiliary information sub1−6 to the index i=6 in the first array a. A sequence number “4” and a quantity “6” are set in the auxiliary information sub1−6. The information processing apparatus sets auxiliary information sub1−7 to the index i=7 in the first array a. A sequence number “3” and a quantity “2” are set in the auxiliary information sub1−7.

The information processing apparatus sets auxiliary information sub1−8 to the index i=8 in the first array a. A sequence number “4” and a quantity “6” are set in the auxiliary information sub1−8. The information processing apparatus sets auxiliary information sub1−9 to the index i=9 in the first array a. A sequence number “4” and a quantity “6” are set in the auxiliary information sub1−9. The information processing apparatus sets auxiliary information sub1−10 to the index i=10 in the first array a. A sequence number “4” and a quantity “6” are set in the auxiliary information sub1−10.

The information processing apparatus sets auxiliary information sub1−11 to the index i=11 in the first array a. A sequence number “4” and a quantity “6” are set in the auxiliary information sub1−11. The information processing apparatus sets auxiliary information sub1−13 to the index i=13 in the first array a. A sequence number “4” and a quantity “6” are set in the auxiliary information sub1−13.

After accepting the orders Or2-1, Or2-2, Or2-3, and Or2-4 in order, the information processing apparatus executes a process on the second array a in a case where the buy order is accepted so as to set the second array a to the state as illustrated in FIG. 6. An element of the index i=0 to 12 of the second array a is “T”, and the other elements are “F”. “T” of the index i=0 is set in an initial state.

The information processing apparatus sets auxiliary information sub2−1 to the index i=1 in the second array a. A sequence number “2” and a quantity “1” are set in the auxiliary information sub2−1. The information processing apparatus sets auxiliary information sub2−2 to the index i=2 in the second array a. A sequence number “4” and a quantity “2” are set in the auxiliary information sub2−2. The information processing apparatus sets auxiliary information sub2−3 to the index i=3 in the second array a. A sequence number “4” and a quantity “2” are set in the auxiliary information sub2−3.

The information processing apparatus sets auxiliary information sub2−4 to the index i=4 in the second array a. A sequence number “3” and a quantity “4” are set in the auxiliary information sub2−4. The information processing apparatus sets auxiliary information sub2−5 to the index i=5 in the second array a. A sequence number “1” and a quantity “5” are set in the auxiliary information sub2−5. The information processing apparatus sets auxiliary information sub2−6 to the index i=6 in the second array a. A sequence number “2” and a quantity “1” are set in the auxiliary information sub2−6.

The information processing apparatus sets auxiliary information sub2−7 to the index i=7 in the second array a. A sequence number “4” and a quantity “2” are set in the auxiliary information sub2−7. The information processing apparatus sets auxiliary information sub2−8 to the index i=8 in the second array a. A sequence number “4” and a quantity “2” are set in the auxiliary information sub2−8. The information processing apparatus sets auxiliary information sub2−9 to the index i=9 in the second array a. A sequence number “3” and a quantity “4” are set in the auxiliary information sub2−9.

The information processing apparatus sets auxiliary information sub2−10 to the index i=10 in the second array a. A sequence number “3” and a quantity “4” are set in the auxiliary information sub2−10. The information processing apparatus sets auxiliary information sub2−11 to the index i=11 in the second array a. A sequence number “4” and a quantity “2” are set in the auxiliary information sub2−11. The information processing apparatus sets auxiliary information sub2−12 to the index i=12 in the second array a. A sequence number “4” and a quantity “2” are set in the auxiliary information sub2−12.

The information processing apparatus compares the first array a with the second array a, and calculates a largest index among indices in which both of an element of the first array a and an element of the second array a are “T”, as a contract count. According to the example illustrated in FIG. 6, the largest index among the indices in which both the element of the first array a and the element of the second array a are “T” is the index i=11. For this reason, the information processing apparatus sets the contract count to “11”.

Based on the “first array a” in FIG. 6, a process in which the information processing apparatus specifies a sell order for a contract will be described.

The information processing apparatus treats, as a contract target, an order corresponding to the auxiliary information sub1−11 set to the index i=11 corresponding to the contract count “11”. The auxiliary information sub1−11 corresponds to the order Or1-4 with the sequence number “4” and the quantity “6”. The information processing apparatus acquires the quantity α=6 included in the auxiliary information sub1−11, and updates the index i=11−6=5.

The information processing apparatus treats an order corresponding to the auxiliary information sub1−5 set to index i=5 as a contract target. The auxiliary information sub1−5 corresponds to the order Or1-2 with the sequence number “2” and the quantity “3”. The information processing apparatus acquires the quantity α=3 included in the auxiliary information sub1−5, and updates the index i=5−3=2.

The information processing apparatus treats an order corresponding to the auxiliary information sub1−2 set to index i=2 as a contract target. The auxiliary information sub1−2 corresponds to the order Or1-1 with the sequence number “1” and the quantity “2”. The information processing apparatus acquires the quantity α=2 included in the auxiliary information sub1−2, and updates the index i=2−2=0. Since the index i=0, the information processing apparatus ends the process.

Based on the “second array a” in FIG. 6, a process in which the information processing apparatus specifies a buy order for a contract will be described.

The information processing apparatus treats, as a contract target, an order corresponding to the auxiliary information sub2−11 set to the index i=11 corresponding to the contract count “11”. The auxiliary information sub2−11 corresponds to the order Or2-4 with the sequence number “4” and the quantity “2”. The information processing apparatus acquires the quantity α=2 included in the auxiliary information sub2−11, and updates the index i=11−2=9.

The information processing apparatus treats an order corresponding to the auxiliary information sub2−9 set to index i=9 as a contract target. The auxiliary information sub2−9 corresponds to the order Or2-3 with the sequence number “3” and the quantity “4”. The information processing apparatus acquires the quantity α=4 included in the auxiliary information sub2−9, and updates the index i=9−4=5.

The information processing apparatus treats an order corresponding to the auxiliary information sub2−5 set to index i=5 as a contract target. The auxiliary information sub2−5 corresponds to the order Or2-1 with the sequence number “1” and the quantity “5”. The information processing apparatus acquires the quantity α=5 included in the auxiliary information sub2−1, and updates the index i=5−5=0. Since the index i=0, the information processing apparatus ends the process.

With the above-described process, the sell orders Or1-1, Or1-2, and Or1-4 and the buy orders Or2-1, Or2-3, and Or2-4 are specified as the contract targets.

As described above, in a case where a sell order is accepted, the information processing apparatus according to Embodiment 1 sets information based on an order sequence and an order count of the sell order to the first array a, and in a case where a buy order is accepted, the information processing apparatus according to Embodiment 1 sets information based on an order sequence and an order count of the buy order to the second array a. The information processing apparatus calculates a maximum contract count based on the information set in the first array a and the information set in the second array a. Based on the calculated maximum contract count, the information set in the first array a, and the information set in the second array a, the information processing apparatus specifies an order to be a contract target. For example, with the information processing apparatus according to Embodiment 1, it is possible to specify an order to be a contract target that maximizes the contract count.

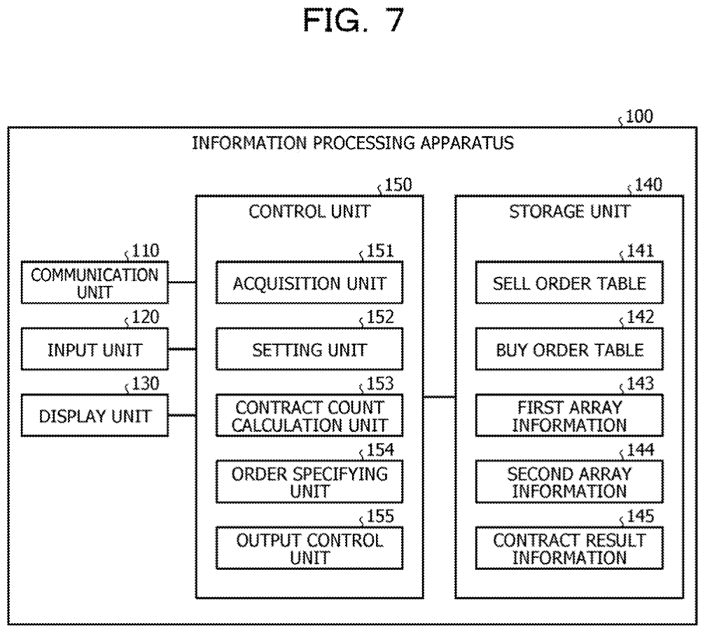

Next, an example of a configuration of the information processing apparatus that executes the processes described with reference to FIGS. 1 to 6 will be described. FIG. 7 is a diagram illustrating a configuration of the information processing apparatus according to Embodiment 1. As illustrated in FIG. 7, an information processing apparatus 100 includes a communication unit 110, an input unit 120, a display unit 130, a storage unit 140, and a control unit 150.

The communication unit 110 is coupled to an external apparatus or the like in a wired or wireless manner, and transmits and receives information to and from the external apparatus or the like. The communication unit 110 is implemented by, for example, a network interface card (NIC) or the like. The communication unit 110 may be coupled to a network (not illustrated). For example, the communication unit 110 receives information on a sell order table 141 including information on sell orders, information on a buy order table 142 including information on buy orders, and the like from the external apparatus. For example, the external apparatus corresponds to a server that manages buying and selling of shares, and executes various types of processes related to an order as a contract target.

The input unit 120 is an input device that inputs various types of information to the information processing apparatus 100. The input unit 120 corresponds to a keyboard, a mouse, a touch panel, or the like.

The display unit 130 is a display device that displays information output from the control unit 150. The display unit 130 corresponds to a liquid crystal display, an organic electroluminescence (EL) display, a touch panel, or the like.

The storage unit 140 includes the sell order table 141, the buy order table 142, first array information 143, second array information 144, and contract result information 145. For example, the storage unit 140 is implemented by a semiconductor memory element such as a random-access memory (RAM) or a flash memory, or a storage device such as a hard disk or an optical disc.

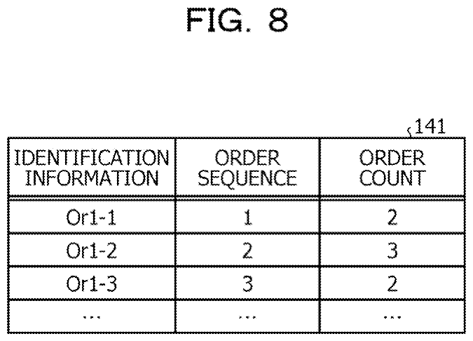

The sell order table 141 is a table in which an order sequence and an order count of the sell order are held. FIG. 8 is a diagram illustrating an example of a data structure of a sell order table according to Embodiment 1. As illustrated in FIG. 8, in the sell order table 141, identification information, an order sequence, and an order count are associated with each other. The identification information is information for uniquely identifying an order. The order sequence is a sequence number of the accepted order. The order count is an order count of the order.

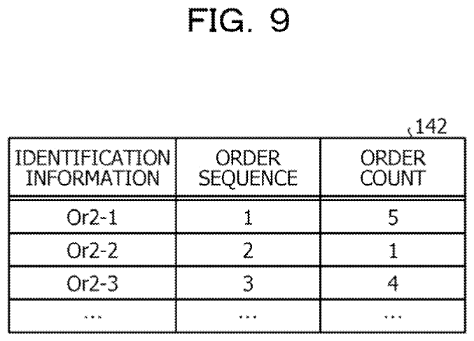

The buy order table 142 is a table in which an order sequence and an order count of the buy order are held. FIG. 9 is a diagram illustrating an example of a data structure of the buy order table 142 according to Embodiment 1. As illustrated in FIG. 9, in the buy order table 142, identification information, an order sequence, and an order count are associated with each other. The identification information is information for uniquely identifying an order. The order sequence is a sequence number of the accepted order. The order count is an order count of the order.

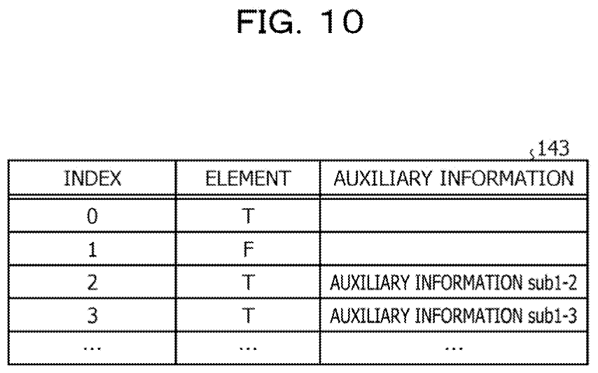

The first array information 143 is array information for holding information based on an order sequence and an order count related to a sell order. The first array information 143 corresponds to the first array a described above. FIG. 10 is a diagram illustrating an example of a data structure of first array information according to Embodiment 1. As illustrated in FIG. 10, the first array information 143 includes an index, an element, and auxiliary information. The index corresponds to the index i of the array a. The element is an element of the array a, and “T” or “F” is set in the element. The auxiliary information is information indicating an order reception sequence (order sequence) and a quantity (order count).

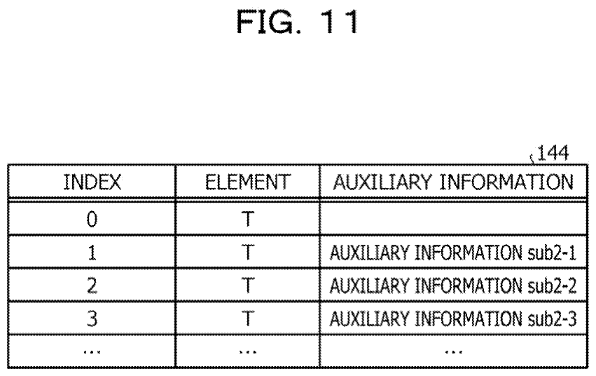

The second array information 144 is array information for holding information based on an order sequence and an order count related to a buy order. The second array information 144 corresponds to the second array a described above. FIG. 11 is a diagram illustrating an example of a data structure of second array information according to Embodiment 1. As illustrated in FIG. 11, the second array information 144 includes an index, an element, and auxiliary information. The index corresponds to the index i of the array a. The element is an element of the array a, and “T” or “F” is set in the element. The auxiliary information is information indicating an order reception sequence (order sequence) and a quantity (order count).

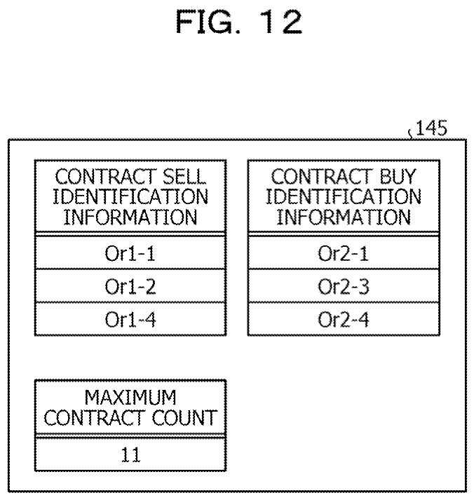

The contract result information 145 holds a maximum contract count and information on an order as a contract target. FIG. 12 is a diagram illustrating an example of a data structure of contract result information according to Embodiment 1. As illustrated in FIG. 12, the contract result information 145 includes contract sell identification information, contract buy identification information, and a maximum contract count. The contract sell identification information is information for identifying a sell order to be a contract target. The contract buy identification information is information for identifying a buy order to be a contract target. The maximum contract count indicates a contract count having the maximum count.

Returning to the description in FIG. 7. The control unit 150 includes an acquisition unit 151, a setting unit 152, a contract count calculation unit 153, an order specifying unit 154, and an output control unit 155. For example, the control unit 150 is implemented by a central processing unit (CPU) or a microprocessor unit (MPU). The control unit 150 may also be implemented by an integrated circuit such as an application-specific integrated circuit (ASIC) or a field-programmable gate array (FPGA), for example.

In a case of acquiring data of the sell order table 141 from an external apparatus or the like, the acquisition unit 151 stores the data of the sell order table 141 in the storage unit 140. The acquisition unit 151 may acquire sell orders individually and sequentially, and register information on the acquired sell orders in the sell order table 141.

In a case of acquiring data of the buy order table 142 from the external apparatus or the like, the acquisition unit 151 stores the data of the buy order table 142 in the storage unit 140. The acquisition unit 151 may acquire buy orders individually and sequentially, and register information on the acquired buy orders in the buy order table 142.

Based on the sell order table 141, the setting unit 152 sets information based on an order sequence and an order count related to a sell order in the first array information 143 (first array a). Based on the buy order table 142, the setting unit 152 sets information based on an order sequence and an order count related to a buy order in the second array information 144 (second array a).

The process in which the setting unit 152 sets the information based on the order sequence and the order count related to the sell order in the first array information 143 based on the sell order table 141 corresponds to the process of the first array a described with reference to FIG. 4. The setting unit 152 sets a[i+x]=T in a case where a sell order of the order count x is accepted at the first array a[i]=T.

For example, regarding the first array information 143, the setting unit 152 sets an element of the index i=i+x to “T”, and sets auxiliary information in which an order reception sequence and a quantity are set, as auxiliary information of the index i=i+x. For each sell order in the sell order table 141, the setting unit 152 repeatedly executes the process described above.

The process in which the setting unit 152 sets the information based on the order sequence and the order count related to the buy order in the second array information 144 based on the buy order table 142 corresponds to a process obtained by replacing the first array a of the process described with reference to FIG. 4 with the second array a. The setting unit 152 sets a[i+x]=T in a case where a sell order of the order count x is accepted at the second array a[i]=T.

For example, regarding the second array information 144, the setting unit 152 sets an element of the index i=i+x to “T”, and sets auxiliary information in which an order reception sequence and a quantity are set, as auxiliary information of the index i=i+x. For each buy order in the buy order table 142, the setting unit 152 repeatedly executes the process described above.

The contract count calculation unit 153 is a processing unit that calculates a maximum contract count between a sell order and a buy order based on the first array information 143 and the second array information 144. A process of the contract count calculation unit 153 corresponds to the process described with reference to FIG. 3. The contract count calculation unit 153 compares the first array information 143 with the second array information 144, and calculates the largest index among indices in which both an element of the first array information 143 and an element of the second array information 144 are “T”, as the maximum contract count. The contract count calculation unit 153 registers the calculated maximum contract count in the contract result information 145.

At a timing when the contract count calculation unit 153 accepts an instruction to determine the contract count from the input unit 120, an external apparatus, or the like, the contract count calculation unit 153 may execute the process described above. At a timing when a predetermined time elapses after the setting unit 152 sets the first array information 143 and the second array information 144, the contract count calculation unit 153 may execute the process described above.

The order specifying unit 154 is a processing unit that specifies an order to be a contract target, based on the maximum contract count, the first array information 143, and the second array information 144. A process of the order specifying unit 154 corresponds to the processes described with reference to FIGS. 5 and 6. In a case where a contract is made with the contract count (the maximum contract count) i₀, the order specifying unit 154 sets an initial value of the index i=i₀, and repeatedly executes the following process until i=0.

The process repeated by the order specifying unit 154 is the following process. The order specifying unit 154 sets an order with a[i]=T as a contract target. Next, the order specifying unit 154 specifies the quantity α included in auxiliary information set in a[i], and updates the index i by i=i−α.

For example, as described with reference to FIG. 5, the order specifying unit 154 executes the above-described process on the first array a (first array information 143) to specify the identification information Or1-1 and Or1-2 of the orders as a contract target. By executing the above-described process on the second array a (second array information 144), the order specifying unit 154 specifies the identification information Or2-1 and Or2-3 of the orders as a contract target.

As described with reference to FIG. 6, the order specifying unit 154 executes the above-described process on the first array a (first array information 143) to specify the identification information Or1-1, Or1-2, and Or1-4 of the orders as the contract targets. By executing the above-described process on the second array a (second array information 144), the order specifying unit 154 specifies the identification information Or2-1, Or2-3, and Or2-4 of the orders as the contract targets.

Next, the order specifying unit 154 registers the identification information of the order specified as the contract target by executing the above-described process, in the contract result information 145.

The output control unit 155 is a processing unit that outputs the contract result information 145 to the display unit 130 so as to display the contract result information 145. The output control unit 155 may transmit the contract result information 145 to an external apparatus, and request the external apparatus to execute various contract processes.

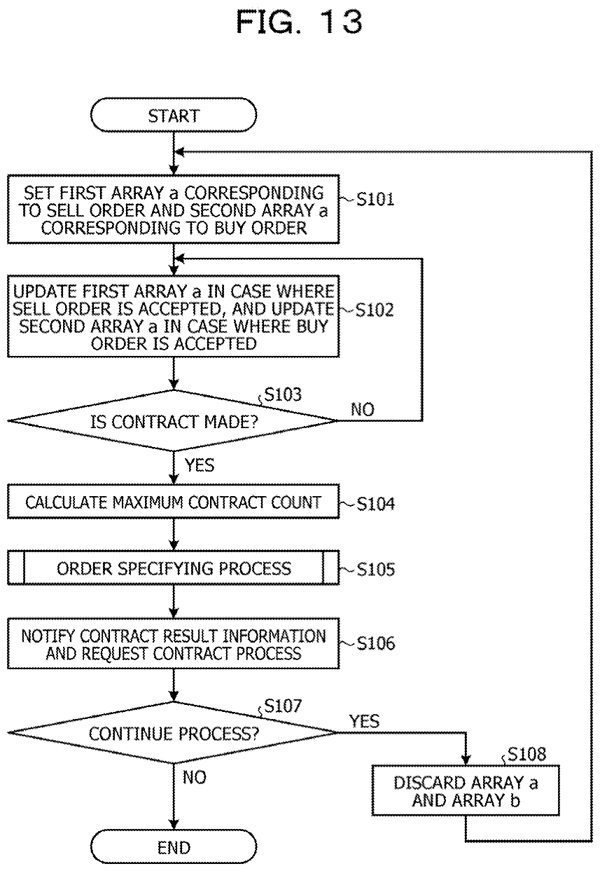

Next, an example of a processing procedure of the information processing apparatus 100 according to Embodiment 1 will be described. FIG. 13 is a flowchart illustrating a processing procedure of the information processing apparatus according to Embodiment 1. As illustrated in FIG. 13, the setting unit 152 of the information processing apparatus 100 sets the first array a related to a sell order and the second array a related to a buy order (step S101). Information on the first array a corresponds to the first array information 143. Information on the second array a corresponds to the second array information 144.

The setting unit 152 updates the first array a in a case where a sell order is accepted, and updates the second array a in a case where a buy order is accepted (step S102). In a case where a contract is not made with this order (No in step S103), the information processing apparatus 100 proceeds to step S102. In a case where the contract is made with this order (Yes in step S103), the information processing apparatus 100 proceeds to step S104.

The contract count calculation unit 153 of the information processing apparatus 100 calculates a maximum contract count (step S104). The order specifying unit 154 of the information processing apparatus 100 executes an order specifying process (step S105).

The output control unit 155 of the information processing apparatus 100 notifies an external apparatus or the like of contract result information, and requests a contract process (step S106). In a case where the process is continued (Yes in step S107), the information processing apparatus 100 proceeds to step S108. The setting unit 152 discards the first array a and the second array a (step S108), and proceeds to step S101.

In a case where the process is not continued (No in step S107), the information processing apparatus 100 ends the process.

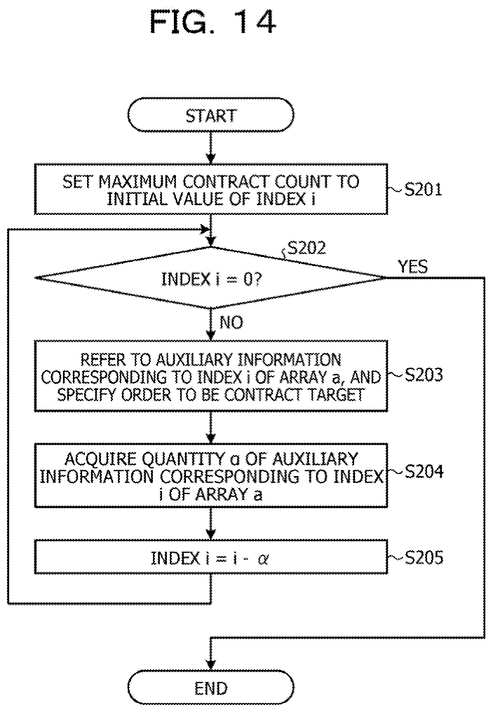

Next, a processing procedure of the order specifying process described in step S105 in FIG. 13 will be described. FIG. 14 is a flowchart illustrating a processing procedure of an order specifying process according to Embodiment 1. The order specifying unit 154 of the information processing apparatus 100 sets a maximum contract count to an initial value of the index i (step S201).

In a case where the index i=0 is satisfied (Yes in step S202), the order specifying unit 154 ends the order specifying process. In a case where the index i=0 is not satisfied (No in step S202), the order specifying unit 154 proceeds to step S203.

The order specifying unit 154 refers to auxiliary information corresponding to the index i of the array a, and specifies an order to be a contract target (step S203). The order specifying unit 154 acquires the quantity α of the auxiliary information corresponding to the index i of the array a (step S204).

By using a value obtained by subtracting a from the index i, the order specifying unit 154 updates the index i (step S205), and proceeds to step S202.

By executing the process illustrated in FIG. 14 on the first array a, the order specifying unit 154 specifies a sell order to be a contract target. By executing the process illustrated in FIG. 14 on the second array a, the order specifying unit 154 specifies a buy order to be a contract target.

Next, effects of the information processing apparatus 100 according to Embodiment 1 will be described. In a case where a sell order is accepted, the information processing apparatus 100 sets information based on an order sequence and an order count of the sell order to the first array a, and in a case where a buy order is accepted, the information processing apparatus 100 sets information based on an order sequence and an order count of the buy order to the second array a. The information processing apparatus 100 calculates a maximum contract count based on the information set in the first array a and the information set in the second array a. Based on the calculated maximum contract count, the information set in the first array a, and the information set in the second array a, the information processing apparatus 100 specifies an order to be a contract target. For example, with the information processing apparatus 100 according to Embodiment 1, it is possible to specify an order to be a contract target that maximizes the contract count.

In a case of accepting information on an order sequence and an order count of a sell order, the information processing apparatus 100 sets the registration symbol “T” in an element of an index of the first array a specified based on the order count, and sets auxiliary information on the order sequence and the order count in association with the index. In a case of accepting information on an order sequence and an order count of a buy order, the information processing apparatus 100 sets the registration symbol “T” in an element of an index of the second array a specified based on the order count, and sets auxiliary information on the order sequence and the order count in association with the index. Accordingly, it is possible to easily specify the maximum contract count by comparing the first array a with the second array a. By using the auxiliary information, it is possible to check the indices of the first array a and the second array a, and specify an order to be a contract target.

Although the case where a total amount of the contract is guaranteed is described in the process of the information processing apparatus 100 described above, the maximum contract count may be specified in the same manner even in a case where a minimum contract count is guaranteed. In the following description, a process in which the information processing apparatus 100 specifies the maximum contract count in a case where an order for which the minimum contract count is designated is accepted will be described.

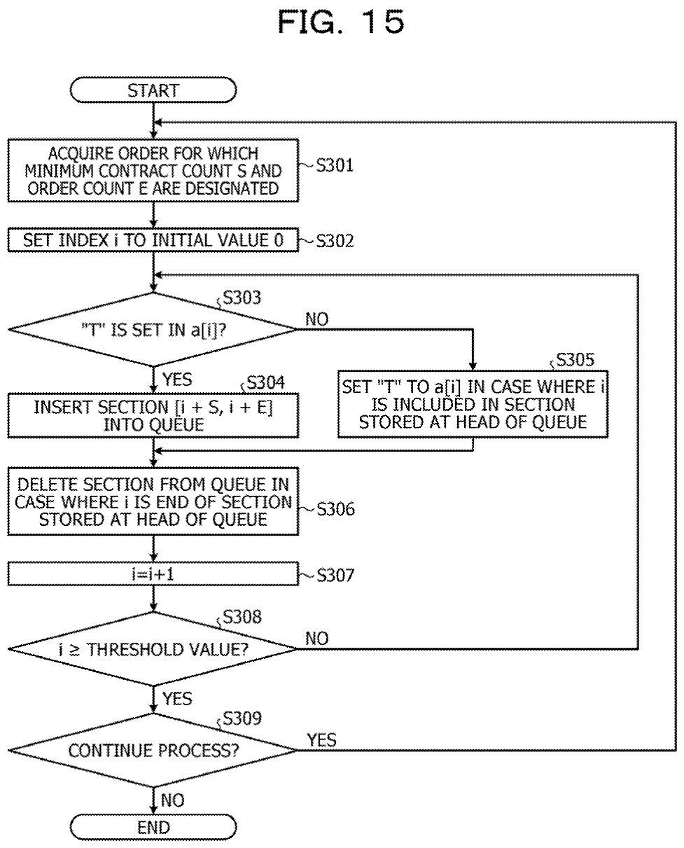

The information processing apparatus 100 prepares a queue for storing an index section in which “T” is set in the array a in the storage unit 140. The setting unit 152 of the information processing apparatus 100 executes a setting process illustrated in FIG. 15 in a case of accepting an order for which a minimum contract count S and an order count E are set.

FIG. 15 is a flowchart illustrating a processing procedure of a setting process in a case where a minimum contract count is guaranteed. As illustrated in FIG. 15, the setting unit 152 of the information processing apparatus 100 acquires an order for which the minimum contract count S and the order count E are designated (step S301).

The setting unit 152 sets the index i to an initial value 0 (step S302). In a case where “T” is set in a[i] (Yes in step S303), the setting unit 152 inserts a section [i+S, i+E] into the queue (step S304), and proceeds to step S306.

In a case where an end section of the queue and the section to be inserted are coupled to each other in step S304, the setting unit 152 merges the sections. For example, when the end section of the queue is [4, 6] and the section to be inserted is [4, 9], the setting unit 152 merges the sections to obtain [4, 9].

By contrast, in a case where “T” is not set in a[i] (No in step S303), the setting unit 152 proceeds to step S305. In a case where i is included in a section stored at a head of the queue, the setting unit 152 sets “T” to a[i] (step S305), and proceeds to step S306.

In a case where i is an end of the section stored at the head of the queue, the setting unit 152 deletes the section from the queue (step S306). By using a value obtained by adding 1 to the index i, the setting unit 152 updates the index i (step S307).

In a case where i is not equal to or greater than a threshold value (No in step S308), the setting unit 152 proceeds to step S303. By contrast, in a case where i is equal to or greater than the threshold value (Yes in step S308), the setting unit 152 proceeds to step S309.

In a case where the process is continued (Yes in step S309), the setting unit 152 proceeds to step S301. In a case where the process is not continued (No in step S309), the setting unit 152 ends the process.

In a case where a sell order in which the minimum contract count S and the order count E are set is accepted, the setting unit 152 executes the process described with reference to FIG. 15 on the first array a (the first array information 143). In a case of accepting a buy order in which the minimum contract count S and the order count E are set, the setting unit 152 executes the process described with reference to FIG. 15 on the second array a (second array information 144).

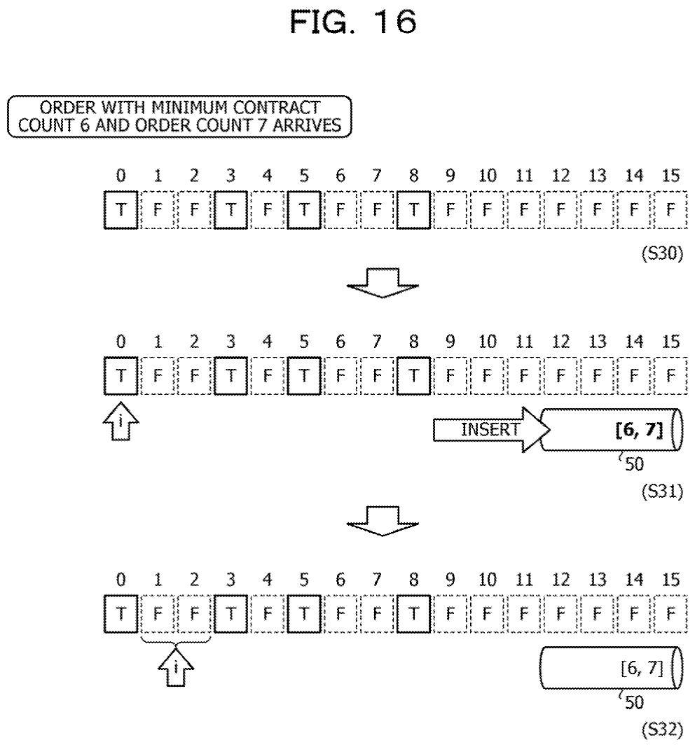

Next, an example of a setting process in a case where a minimum contract count is guaranteed will be described. FIGS. 16 to 19 are diagrams describing the setting process in the case where the minimum contract count is guaranteed. In FIGS. 16 to 19, description of auxiliary information is omitted. As an example, a case where the setting unit 152 accepts a sell order in which the minimum contract count S=6 and the order count E=7 are set and updates the first array a will be described. As illustrated in step S30 in FIG. 16, a state of the first array a is a[0]=T, a[3]=T, a[5]=T, and a[8]=T, and other elements are “F”.

Next, step S31 will be described. The setting unit 152 sets the index i=0. Since a[i]=T is satisfied, the setting unit 152 inserts a section [6, 7](=[0+6, 0+7]) into a queue 50.

Next, step 32 will be described. The setting unit 152 sets the index i=1. Since a[i]=F is satisfied and i is not included in the head section [6, 7] of the queue 50, no process is executed, for example. The setting unit 152 sets the index i=2. Since a[i]=F is satisfied and i is not included in the head section [6, 7] of the queue 50, no process is executed, for example.

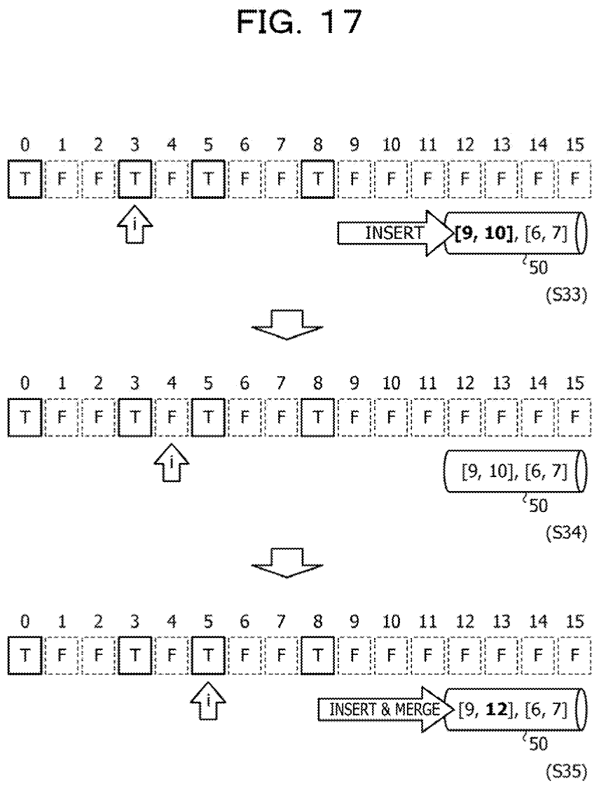

Description continues with reference to FIG. 17. Next, step S33 will be described. The setting unit 152 sets the index i=3. Since a[i]=T is satisfied, the setting unit 152 inserts a section [9, 10] (=[3+6, 3+7]) into the queue 50.

Next, step S34 will be described. The setting unit 152 sets the index i=4. Since a[i]=F is satisfied and i is not included in the head section [6, 7] of the queue 50, no process is executed, for example.

Next, step S35 will be described. The setting unit 152 sets the index i=5. Since a[i]=T is satisfied, the setting unit 152 inserts a section [11, 12] (=[5+6, 5+7]) into the queue 50. The setting unit 152 sets a section [9, 12] obtained by merging the section [9, 10] and the section [11, 12] at an end of the queue 50.

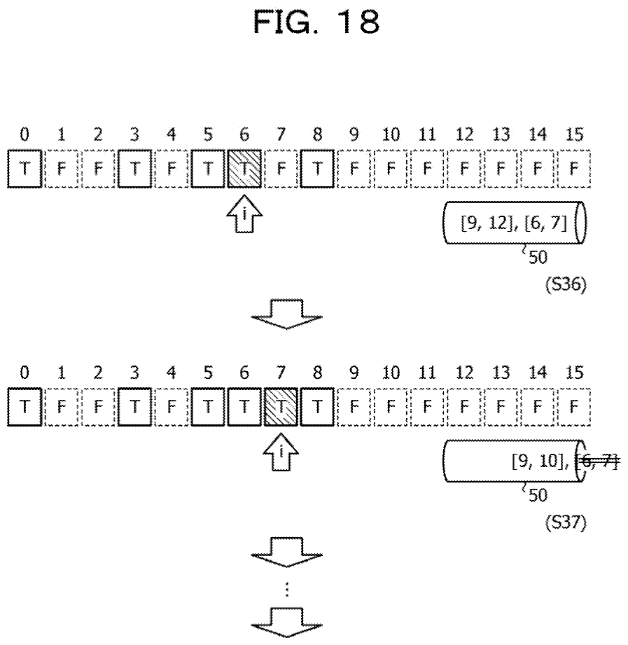

Description continues with reference to FIG. 18. Next, step S36 will be described. The setting unit 152 sets the index i=6. Since a[i]=F is satisfied and i is included in the head section [6, 7] of the queue 50, a[i] is set to T.

Next, step S37 will be described. The setting unit 152 sets the index i=7. Since a[i]=F is satisfied and i is included in the head section [6, 7] of the queue 50, a[i] is set to T. Since i is an end of the head section [6, 7], the setting unit 152 deletes the section [6, 7] from the queue 50.

For the index i=8 to 14, the setting unit 152 repeatedly executes the process described above. Description of the process of the setting unit 152 when the index i=8 to 14 is set will be omitted.

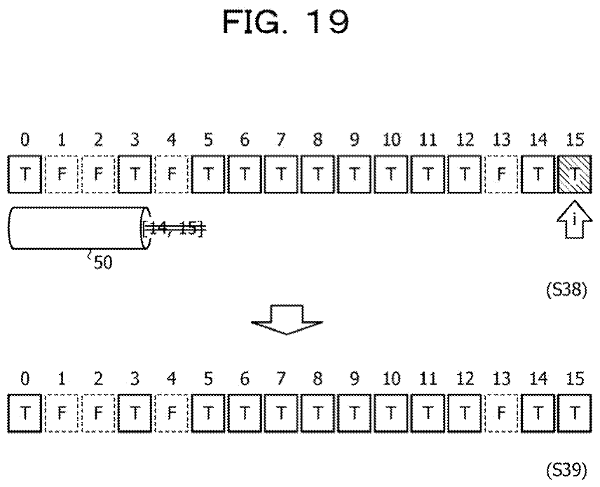

Description continues with reference to FIG. 19. Next, step S38 will be described. The setting unit 152 sets the index i=15. Since a[i]=F is satisfied and i is included in a head section [14, 15] of the queue 50, a[i] is set to T. Since i is an end of the head section [14, 15], the setting unit 152 deletes the section [14, 15] from the queue 50.

Next, step S39 will be described. Since T exceeds the set largest index i=8 and the queue 50 becomes empty in the first array a, the setting unit 152 ends the process.

With the above description with reference to FIGS. 16 to 19, a case where the setting unit 152 accepts a sell order for which a minimum contract count and an order count are set, and updates the first array a is described. Also in a case of accepting a buy order for which a minimum contract count and an order count are set and updating the second array a, the setting unit 152 performs the update in the same manner as the process in FIGS. 16 to 19.

Based on the first array a (first array information 143) and the second array a (second array information 144) updated by the setting unit 152, the contract count calculation unit 153 of the information processing apparatus 100 calculates a maximum contract count. For example, the contract count calculation unit 153 compares the first array information 143 with the second array information 144, and calculates the largest index among indices in which both an element of the first array information 143 and an element of the second array information 144 are “T”, as the maximum contract count. Such a maximum contract count is a contract count for guaranteeing a minimum contract count.

### Embodiment 2

Before describing an information processing apparatus according to Embodiment 2, in a securities market, a market in which a total amount contract order with a designated price is made will be considered. Conditions in a case of the contract are set as the following conditions (1), (2), and (3).

Condition (1): all contracts are made with sell orders with an amount equal to or greater than a desirable price and a partial contract is not made.

Condition (2): all contracts are made with buy orders with an amount equal to or less than a desirable price and a partial contract is not made.

Condition (3): stock exchange does not lose (a total amount of money obtained by a buy order has to be equal to or less than a total amount of money obtained by a sell order (when viewed from stock exchange point of view)).

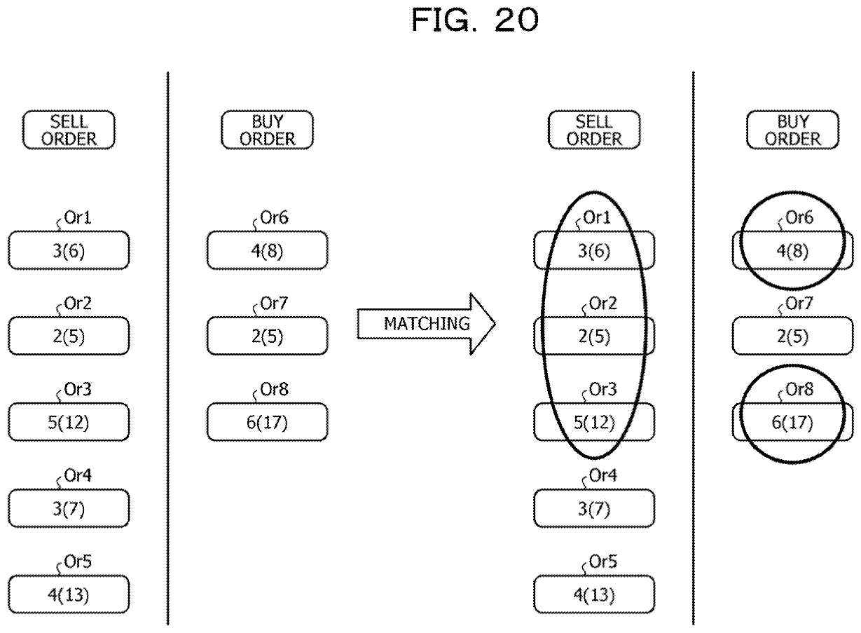

FIG. 20 is a diagram illustrating an example of matching between a sell order and a buy order related to a total amount contract order for which a price is designated. In the example illustrated in FIG. 20, orders Or1, Or2, Or3, Or4, and Or5 exist as sell orders. The order Or1 is an order in which an order count is “3” and a transaction amount of money is “60000 yen”. The order Or2 is an order in which an order count is “2” and a transaction amount of money is “50000 yen”. The order Or3 is an order in which an order count is “5” and a transaction amount of money is “120000 yen”. The order Or4 is an order in which an order count is “3” and a transaction amount of money is “70000 yen”. The order Or5 is an order in which an order count is “4” and a transaction amount of money is “130000 yen”.

Order Or6, Or7, and Or8 exist as buy orders. The order Or6 is an order in which an order count is “4” and a transaction amount of money is “80000 yen”. The order Or7 is an order in which an order count is “2” and a transaction amount of money is “50000 yen”. The order Or8 is an order in which an order count is “6” and a transaction amount of money is “170000 yen”. Each transaction amount of money of the sell order and the buy order indicates a transaction amount of money for the order count.

Under the condition (1) to (3), in a case where a contract count is maximized for the sell order and the buy order illustrated in FIG. 20, a matching result is as follows. For example, contract targets are the sell orders Or1, Or2, and Or3 and the buy orders Or6 and Or8. Since a total order count of the sell orders Or1, Or2, and Or3 is “10” and a total transaction amount of money is “23” and a total order count of the buy orders Or6 and Or8 is “10” and a total transaction amount of money is “25”, the conditions (1) to (3) are satisfied.

Meanwhile, in a case where the matching described with reference to FIG. 20 is performed, a knapsack problem occurs, so it is difficult to solve the problem unless a certain condition is provided.

The information processing apparatus according to Embodiment 2 will be described. The information processing apparatus according to Embodiment 2 prepares an array for a price to manage each of a sell order and a buy order. An array of a price of the sell order is referred to as the array a, and an array of a price of the buy order is referred to as an array b. The array a corresponds to a first array, and the array b corresponds to a second array.

The index i equal to or greater than 0 is set for the arrays a and b. The index i corresponds to a contract count (order count). For an element corresponding to the index i of the array, a minimum value of a transaction amount of money in a contract is set. As initial values of the array a, the information processing apparatus sets a[i]=∞ (sufficiently large value) for a[0]=0 and the index i>0. As initial values of the array b, the information processing apparatus sets b[i]=∞ (sufficiently large value) for b[0]=0 and the index i>0.

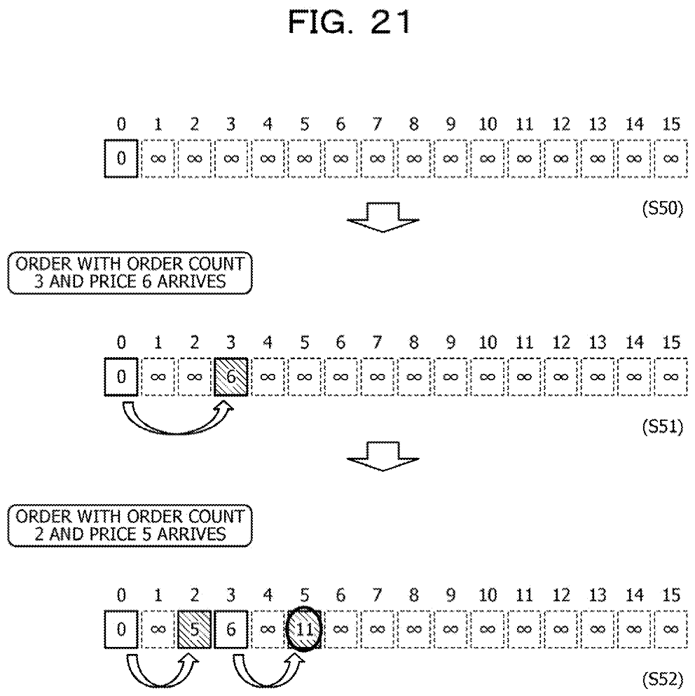

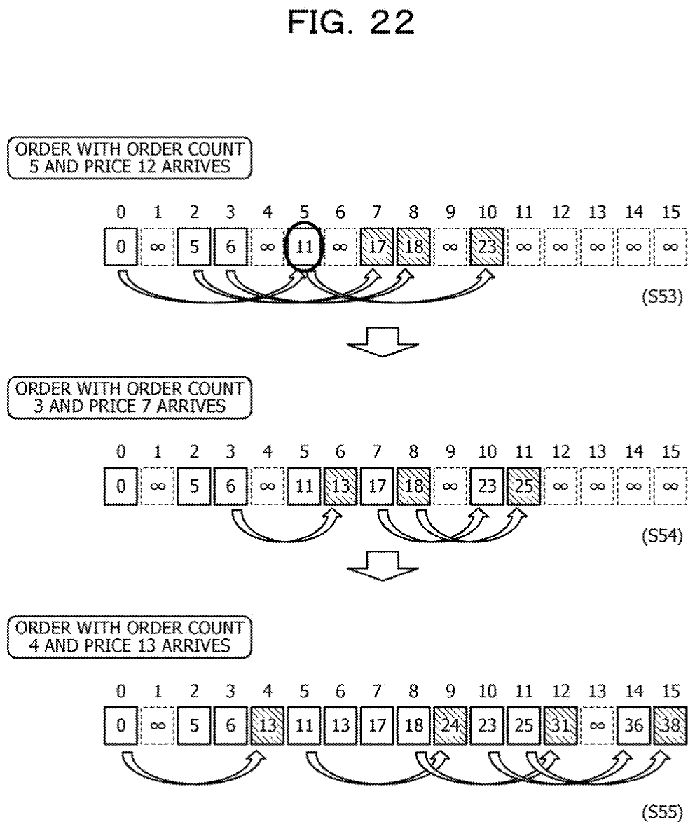

First, a process in which the information processing apparatus according to Embodiment 2 calculates a maximum matchable contract count will be described. FIGS. 21 and 22 are diagrams describing a process on the array a in a case where a sell order is accepted. In a case where an order having the order count x and a price p arrives when a[i]<∞, the information processing apparatus sets a[i+x]=a[i]+p (updates when a value of an element decreases) when a[i+x]>a[i]+p.

FIG. 21 will be described. An initial state of the array a is illustrated in step S50. In the initial state of the array a, a[0]=0 and all other elements are 00.

In a case where a sell order having an order count 3 and a price 6 (10000 yen, to be omitted below) is accepted, a state of the array a is as illustrated in step S51. Since the array is a[0+3]=∞ and a[0]+p=6, the array is a[0+3]>a[0]+p. For this reason, the information processing apparatus sets the array a[0+3]=6.

In a case where a sell order having an order count 2 and a price 5 is accepted, the state of the array a is as illustrated in step S52. Since the array is a[0+2]=∞ and a[0]+p=5, the array is a[0+2]>a[0]+p. For this reason, the information processing apparatus sets the array a[0+2]=5. Since the array is a[3+2]=∞ and a[3]+p=11, the array is a[3+2]>a[3]+p. For this reason, the information processing apparatus sets the array a[3+2]=11.

Description continues with reference to FIG. 22. In a case where a sell order having an order count 5 and a price 12 is accepted, the state of the array a is as illustrated in step S53. Since the array is a[0+5]=11 and a[0]+p=12, the array is a[0+5]<a[0]+p. For this reason, the information processing apparatus keeps the array a[0+5]=11 (does not update).

Since the array is a[2+5]=∞ and a[2]+p=17, the array is a[2+5]>a[2]+p. For this reason, the information processing apparatus sets the array a[2+5]=17. Since the array is a[3+5]=∞ and a[3]+p=18, the array is a[3+5]>a[3]+p. For this reason, the information processing apparatus sets the array a[3+5]=18.

Since the array is a[5+5]=∞ and a[5]+p=13, the array is a[5+5]>a[5]+p. For this reason, the information processing apparatus sets the array a[5+5]=23.

In a case where a sell order having an order count 3 and a price 7 is accepted, the state of the array a is as illustrated in step S54. Since the array is a[0+3]=6 and a[0]+p=7, the array is a[0+3]<a[0]+p. For this reason, the information processing apparatus keeps the array a[0+3]=6 (does not update). Since the array is a[2+3]=11 and a[2]+p=12, the array is a[2+3]<a[2]+p. For this reason, the information processing apparatus keeps the array a[2+3]=11 (does not update).

Since the array is a[3+3]=∞ and a[3]+p=13, the array is a[3+3]>a[3]+p. For this reason, the information processing apparatus sets the array a[3+3]=13. Since the array is a[3+5]=18 and a[5]+p=18, the array is a[3+5]=a[5]+p. For this reason, the information processing apparatus keeps the array a[3+5]=18.

Since the array is a[7+3]=23 and a[7]+p=24, the array is a[7+3]<a[7]+p. For this reason, the information processing apparatus keeps the array a[7+3]=13 (does not update). Since the array is a[8+3]=Co and a[8]+p=25, the array is a[8+3]>a[8]+p. For this reason, the information processing apparatus sets the array a[8+3]=25.

In a case where a sell order having an order count 4 and a price 13 is accepted, the state of the array a is as illustrated in step S55. Since the array is a[0+4]=∞ and a[0]+p=13, the array is a[0+4]>a[0]+p. For this reason, the information processing apparatus sets the array a[0+4]=13. Since the array is a[2+4]=13 and a[2]+p=18, the array is a[2+4]<a[2]+p. For this reason, the information processing apparatus keeps the array a[2+4]=13 (does not update).

Since the array is a[3+4]=17 and a[3]+p=19, the array is a[3+4]<a[3]+p. For this reason, the information processing apparatus keeps the array a[3+4]=17 (does not update). Since the array is a[5+4]=Co and a[5]+p=24, the array is a[5+6]>a[5]+p. For this reason, the information processing apparatus sets the array a[5+4]=24.

Since the array is a[6+4]=23 and a[6]+p=24, the array is a[6+4]<a[6]+p. For this reason, the information processing apparatus keeps the array a[6+4]=23 (does not update). Since the array is a[7+4]=25 and a[7]+p=28, the array is a[7+4]<a[7]+p. For this reason, the information processing apparatus keeps the array a[7+4]=25 (does not update).

Since the array is a[8+4]=∞ and a[8]+p=31, the array is a[8+4]>a[8]+p. For this reason, the information processing apparatus sets the array a[8+4]=31. Since the array is a[10+4]=∞ and a[10]+p=36, the array is a[10+4]>a[10]+p. For this reason, the information processing apparatus sets the array a[10+4]=36. Since the array is a[11+4]=Co and a[11]+p=38, the array is a[11+4]>a[11]+p. For this reason, the information processing apparatus sets the array a[11+4]=38.

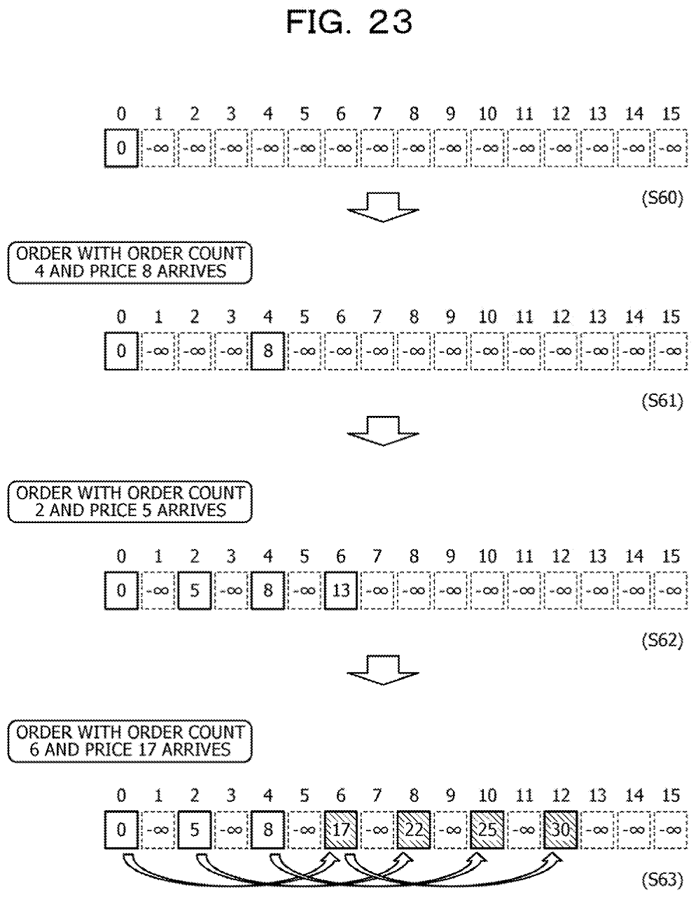

FIG. 23 is a diagram describing a process on the array b in a case where a buy order is accepted. In a case where an order having the order count x and the price p arrives when b[i]>−∞, the information processing apparatus sets b[i+x]=b[i]+p (updates when a value of an element increases) when b[i+x]<b[i]+p.

An initial state of the array b is illustrated in step S60. At an initial state of the array b, b[0]=0 is set, and all other elements are set to “−∞”.

In a case where a buy order having an order count 4 and a price 8 (10000 yen, to be omitted below) is accepted, a state of the array b is as illustrated in step S61. Since the array is b[0+4]=−∞ and b[0]+p=8, the array is b[0+4]<b[0]+p. For this reason, the information processing apparatus sets the array b[0+4]=8.

In a case where a buy order having an order count 2 and a price 5 is accepted, the state of the array b is as illustrated in step S62. Since the array is b[0+2]=−∞ and b[0]+p=5, the array is b[0+2]<b[0]+p. For this reason, the information processing apparatus sets the array b[0+2]=5. Since the array is b[4+2]=−∞ and b[4]+p=13, the array is b[4+2]<b[4]+p. For this reason, the information processing apparatus sets the array b[4+2]=13.

In a case where a buy order having an order count 6 and a price 17 is accepted, the state of the array b is as illustrated in step S63. Since the array is b[0+6]=−∞ and b[0]+p=17, the array is b[0+6]<b[0]+p. For this reason, the information processing apparatus sets the array b[0+6]=17.

Since the array is b[2+6]=−∞ and b[2]+p=22, the array is b[2+6]<b[2]+p. For this reason, the information processing apparatus sets the array b[2+6]=22. Since the array is b[4+6]=−∞ and b[4]+p=25, the array is b[4+6]<b[4]+p. For this reason, the information processing apparatus sets the array b[4+6]=25.

Since the array is b[6+6]=−∞ and b[6]+p=30, the array is b[6+6]<b[6]+p. For this reason, the information processing apparatus sets the array b[6+6]=30.

The information processing apparatus according to Embodiment 2 compares the array a described with reference to FIGS. 21 and 22 and the array b described with reference to FIG. 23, and specifies a maximum matchable contract quantity.

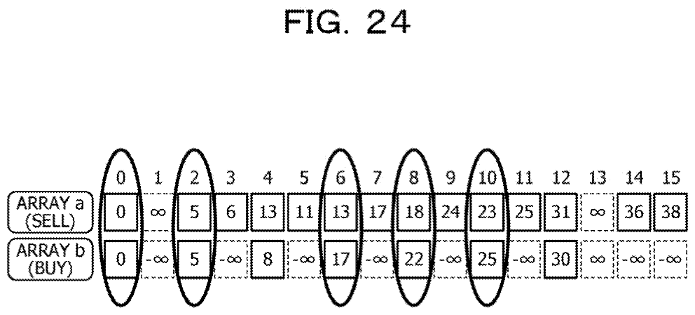

FIG. 24 is a diagram describing an example of a process of calculating a contract count according to Embodiment 2. The information processing apparatus scans the array a of sell orders and the array b of buy orders for each index, and calculates the maximum index i at which a[i] b[i] is satisfied, as a maximum contract amount. According to the example illustrated in FIG. 24, the maximum index among indices at which a[i] b[i] is satisfied is the index i=10, so the information processing apparatus sets the maximum contract count to “10”.

In the same manner as the information processing apparatus 100 described in Embodiment 1, the information processing apparatus according to Embodiment 2 registers auxiliary information indicating an order reception sequence (order sequence) and a quantity (order count) for each index, so that it is possible to specify an order to be a contract target.

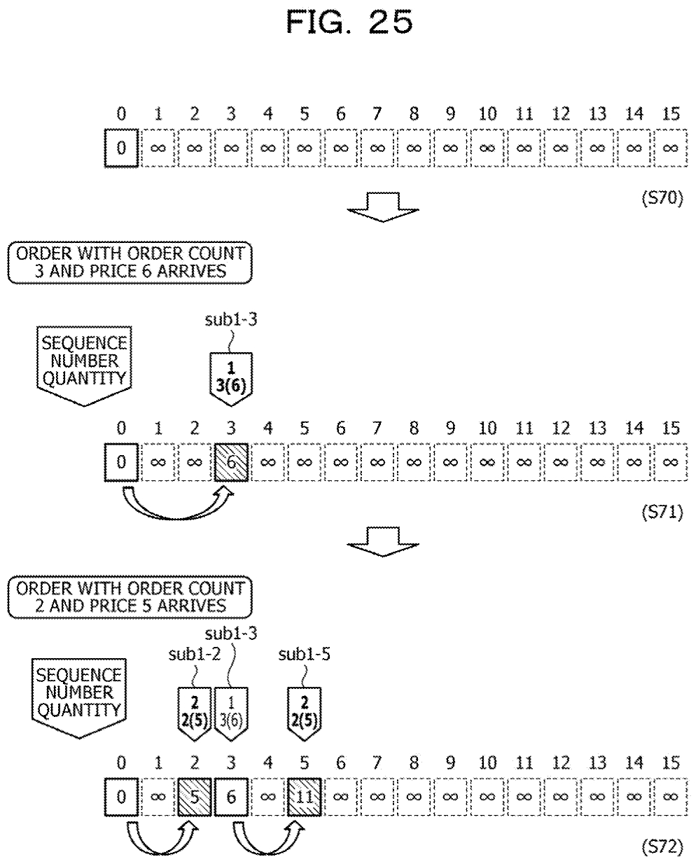

FIG. 25 is a diagram (3) describing a process on the array a in a case where a sell order is accepted. An initial state of the array a is illustrated in step S70. In the initial state of the array a, a[0]=0 and all other elements are 00.

First (order reception sequence=1), in a case where a sell order having an order count 3 and a price 6 is accepted, the state of the array a is as illustrated in step S71. In the same manner as in step S51 in FIG. 21, the information processing apparatus sets a[0+3]=6. The information processing apparatus registers the auxiliary information sub1−3 in the index i=3. The sequence number “1” and the quantity “3 (price 6)” are set in the auxiliary information sub1−3.

Next (order reception sequence=2), in a case where a sell order having an order count 2 and a price 5 is accepted, the state of the array a is as illustrated in step S72. In the same manner as in step S52 in FIG. 21, the information processing apparatus sets a[0+2]=5. The information processing apparatus registers the auxiliary information sub1−2 in the index i=2. The sequence number “2” and the quantity “2 (price 5)” are set in the auxiliary information sub1−2.

In the same manner as in step S52 in FIG. 21, the information processing apparatus sets a[3+2]=11. The information processing apparatus registers the auxiliary information sub1−5 in the index i=5. The sequence number “2” and the quantity “2 (price 5)” are set in the auxiliary information sub1−5.

Each time a sell order is accepted, the information processing apparatus repeatedly executes the process described above.

Although not illustrated, also in a case where a buy order is accepted, the information processing apparatus sets a price in an element of the array b, and registers auxiliary information in an index, in the same manner as in FIG. 25. A process in which the information processing apparatus sets the price in the element of the array b has the same manner as the process illustrated in FIG. 23.

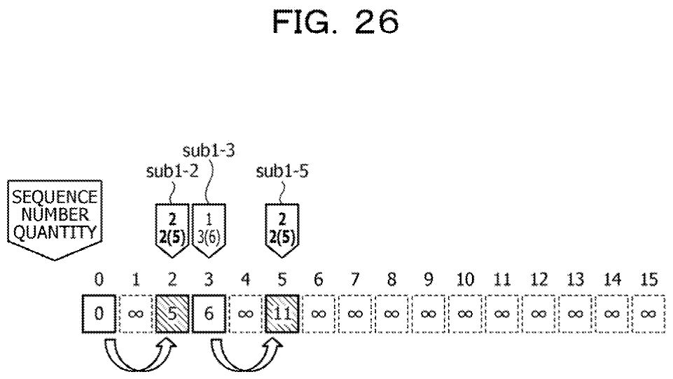

FIG. 26 is a diagram describing a process of specifying an order to be a contract target according to Embodiment 2. The process of specifying the order to be the contract target according to Embodiment 2 has fundamentally the same manner as the processes described with reference to FIGS. 5 and 6.

After calculating the contract count, the information processing apparatus specifies an order as a contract target, based on the auxiliary information set in the array a. In a case of a contract with the contract count i₀, the information processing apparatus sets an initial value of the index i=i₀, and repeatedly executes the following process until i=0.

A process repeated by the information processing apparatus is the following process. The information processing apparatus treats an order of a[i] corresponding to the index i as a contract target. Next, the information processing apparatus specifies the quantity α included in the auxiliary information set in a[i], and updates the index i by i=i-a.

Based on the array a in FIG. 26, a process in which the information processing apparatus specifies a sell order for a contract will be described. It is assumed that i₀=5. The information processing apparatus treats, as a contract target, an order corresponding to the auxiliary information sub1−5 set to the index i=5 corresponding to the contract count “5”. The information processing apparatus acquires the quantity α=2 included in the auxiliary information sub1−5, and updates the index i=5−2=3.

The information processing apparatus treats an order corresponding to the auxiliary information sub1−3 set to the index i=3 as a contract target. The information processing apparatus acquires the quantity α=3 included in the auxiliary information sub1−3, and updates the index i=3−3=0. Since the index i=0, the information processing apparatus ends the process.

With the process described above, the information processing apparatus specifies the “sell order having the order count 3 and the price 6” and the “sell order having the order count 2 and the price 5” described with reference to FIG. 25 as the contract targets. Although not illustrated, the information processing apparatus also executes the process corresponding to FIG. 26 on the array b, and specifies a buy order to be a contract target.

As described above, in a case where a sell order is accepted, the information processing apparatus according to Embodiment 2 sets information based on an order sequence, an order count, and a price of the sell order to the array a, and in a case where a buy order is accepted, the information processing apparatus according to Embodiment 2 sets information based on an order sequence, an order count, and a price of the buy order to the array b. The information processing apparatus calculates a maximum contract count based on the information set in the array a and the information set in the array b. Based on the calculated maximum contract count, the information set in the array a, and the information set in the array b, the information processing apparatus specifies an order to be a contract target. For example, with the information processing apparatus according to Embodiment 2, it is possible to specify an order to be a contract target that maximizes a contract count while satisfying the conditions (1), (2), and (3).

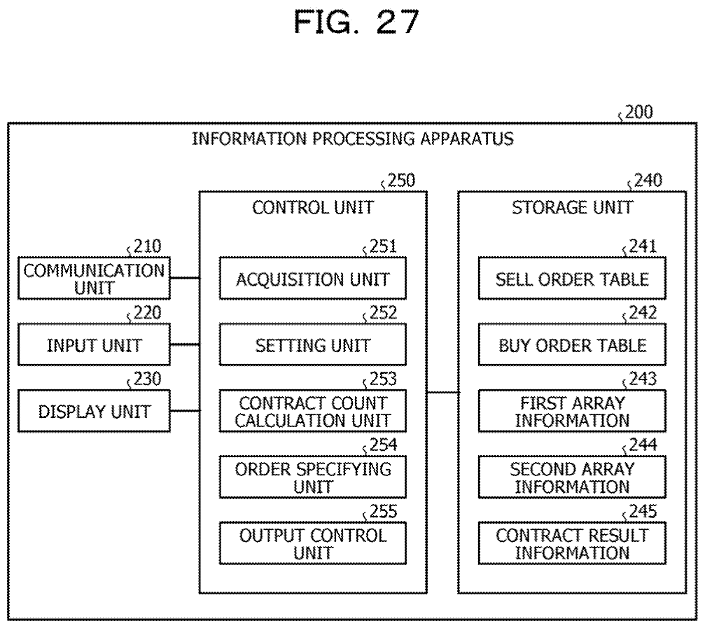

Next, an example of a configuration of the information processing apparatus that executes the processes described with reference to FIGS. 21 to 26 will be described. FIG. 27 is a diagram illustrating a configuration of the information processing apparatus according to Embodiment 2. As illustrated in FIG. 27, an information processing apparatus 200 includes a communication unit 210, an input unit 220, a display unit 230, a storage unit 240, and a control unit 250.

The communication unit 210 is coupled to an external apparatus or the like in a wired or wireless manner, and transmits and receives information to and from the external apparatus or the like. For example, the communication unit 210 is implemented by an NIC or the like. The communication unit 210 may be coupled to a network (not illustrated). For example, the communication unit 210 receives information on a sell order table 241 including information on sell orders, information on a buy order table 242 including information on buy orders, and the like from the external apparatus. For example, the external apparatus corresponds to a server that manages buying and selling of shares, and executes various types of processes related to an order as a contract target.

The input unit 220 is an input device that inputs various types of information to the information processing apparatus 200. The input unit 220 corresponds to a keyboard, a mouse, a touch panel, or the like.

The display unit 230 is a display device that displays information output from the control unit 250. The display unit 230 corresponds to a liquid crystal display, an organic EL display, a touch panel, or the like.

The storage unit 240 includes the sell order table 241, the buy order table 242, first array information 243, second array information 244, and contract result information 245. For example, the storage unit 240 is implemented by a semiconductor memory element such as a RAM or a flash memory, or a storage device such as a hard disk or an optical disc.

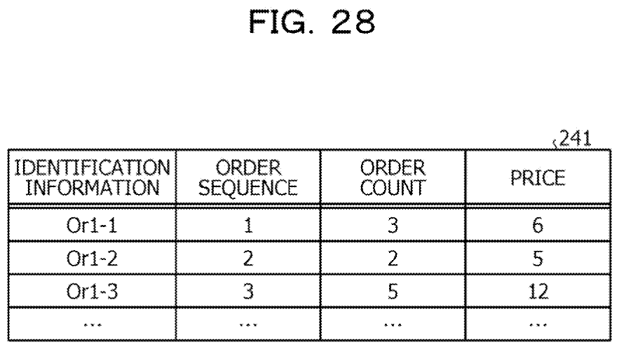

The sell order table 241 is a table in which an order sequence, an order count, and a price of a sell order are held. FIG. 28 is a diagram illustrating an example of a data structure of a sell order table according to Embodiment 2. As illustrated in FIG. 28, in the sell order table 241, identification information, an order sequence, an order count, and a price are associated with each other. The identification information is information for uniquely identifying an order. The order sequence is a sequence number of the accepted order. The order count is an order count of the order. The price is a designated price of the sell order.

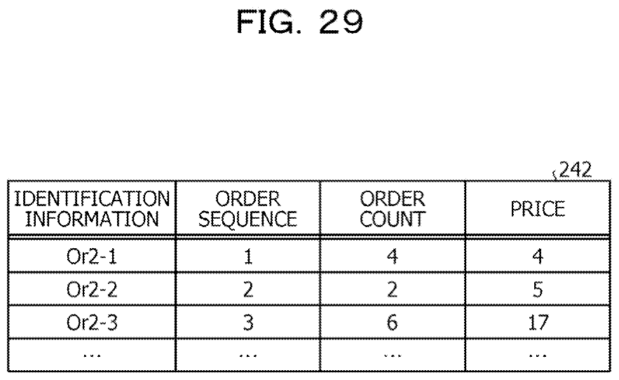

The buy order table 242 is a table in which an order sequence, an order count, a price of a buy order are held. FIG. 29 is a diagram illustrating an example of a data structure of the buy order table 242 according to Embodiment 2. As illustrated in FIG. 29, in the buy order table 242, identification information, an order sequence, an order count, and a price are associated with each other. The identification information is information for uniquely identifying an order. The order sequence is a sequence number of the accepted order. The order count is an order count of the order. The price is a designated price of the buy order.

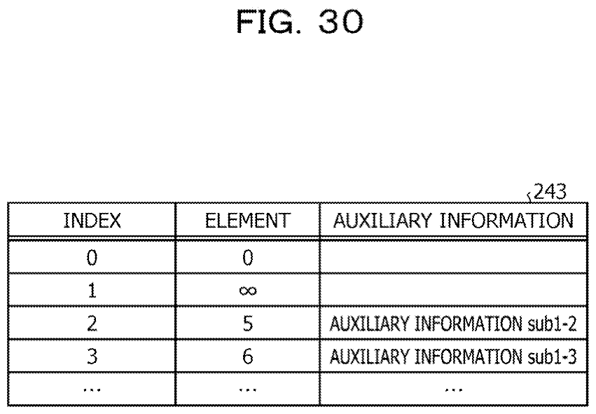

The first array information 243 is array information for holding information based on an order sequence, an order count, and a price related to a sell order. The first array information 243 corresponds to the array a described above. FIG. 30 is a diagram illustrating an example of a data structure of first array information. As illustrated in FIG. 30, the first array information 243 includes an index, an element, and auxiliary information. The index corresponds to the index i of the array a. The element is an element of the array a, and a price is set in the element. The auxiliary information is information indicating an order reception sequence (order sequence) and a quantity (order count).

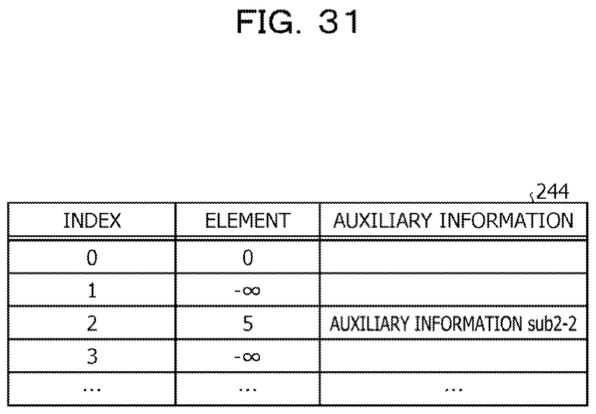

The second array information 244 is array information for holding information based on an order sequence, an order count, and a price related to a buy order. The second array information 244 corresponds to the array b described above. FIG. 31 is a diagram illustrating an example of a data structure of second array information according to Embodiment 2. As illustrated in FIG. 31, the second array information 244 includes an index, an element, and auxiliary information. The index corresponds to the index i of the array b. The element is an element of the array b, and a price is set in the element. The auxiliary information is information indicating an order reception sequence (order sequence) and a quantity (order count).

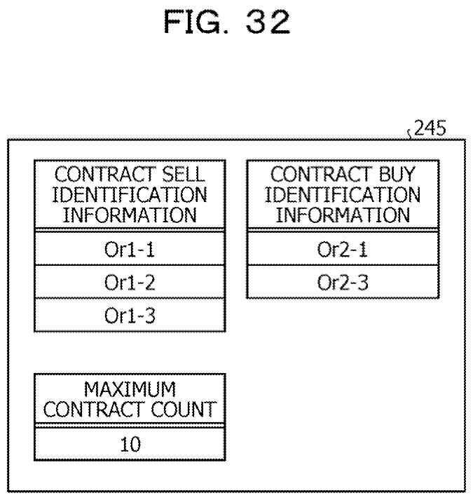

The contract result information 245 holds a maximum contract count and information on an order as a contract target. FIG. 32 is a diagram illustrating an example of a data structure of contract result information according to Embodiment 2. As illustrated in FIG. 32, the contract result information 245 includes contract sell identification information, contract buy identification information, and a maximum contract count. The contract sell identification information is information for identifying a sell order to be a contract target. The contract buy identification information is information for identifying a buy order to be a contract target. The maximum contract count indicates a contract count having the maximum count.

Returning to the description in FIG. 27. The control unit 250 includes an acquisition unit 251, the setting unit 252, the contract count calculation unit 253, the order specifying unit 254, and the output control unit 255. For example, the control unit 250 is implemented by a CPU or an MPU. The control unit 250 may also be implemented by an integrated circuit such as an ASIC or an FPGA, for example.

In a case of acquiring data of the sell order table 241 from an external apparatus or the like, the acquisition unit 251 stores the data of the sell order table 241 in the storage unit 240. The acquisition unit 251 may acquire sell orders individually and sequentially, and register information on the acquired sell orders in the sell order table 241.

In a case of acquiring data of the buy order table 242 from the external apparatus or the like, the acquisition unit 251 stores the data of the buy order table 242 in the storage unit 240. The acquisition unit 251 may acquire buy orders individually and sequentially, and register information on the acquired buy orders in the buy order table 242.

Based on the sell order table 241, the setting unit 252 sets information based on an order sequence, an order count, and a price related to the sell order in the first array information 243 (array a). Based on the buy order table 242, the setting unit 252 sets information based on an order sequence and an order count related to the buy order in the second array information 244 (array b).

The process in which the setting unit 252 sets information based on the order sequence, the order count, and the price related to the sell order in the first array information 243 based on the sell order table 241 corresponds to the process on the array a described with reference to FIGS. 21, 22, 26, and the like. In a case where an order having the order count x and the price p arrives when a[i]<∞, the setting unit 252 sets a[i+x]=a[i]+p (updates when a value of an element decreases) when a[i+x]>a[i]+p. In a case of updating, the setting unit 252 registers auxiliary information in association with the index i.

The process in which the setting unit 252 sets information based on the order sequence, the order count, and the price related to the buy order in the second array information 244 based on the buy order table 242 corresponds to the process on the array b described with reference to FIG. 23 and the like. In a case where an order having the order count x and the price p arrives when b[i]>−∞, the setting unit 252 sets b[i+x]=b[i]+p (updates when a value of an element increases) when b[i+x]<b[i]+p. In a case of updating, the setting unit 252 registers auxiliary information in association with the index i.

The contract count calculation unit 253 is a processing unit that calculates a maximum contract count between a sell order and a buy order based on the first array information 243 and the second array information 244. A process of the contract count calculation unit 253 corresponds to the process described with reference to FIG. 24. The contract count calculation unit 253 scans the first array information 243 (array a) and the second array information 244 (array b) for each index, and calculates a maximum index i at which a[i]b[i] is satisfied, as a maximum contract amount. The contract count calculation unit 253 registers the calculated maximum contract count in the contract result information 245.

At a timing when the contract count calculation unit 253 accepts an instruction to determine the contract count from the input unit 220, an external apparatus, or the like, the contract count calculation unit 253 may execute the process described above. At a timing when a predetermined time elapses after the setting unit 252 sets the first array information 243 and the second array information 244, the contract count calculation unit 253 may execute the process described above.

The order specifying unit 254 is a processing unit that specifies an order to be a contract target, based on the maximum contract count, the first array information 243, and the second array information 244. A process of the order specifying unit 254 corresponds to the process described with reference to FIG. 26. In a case where a contract is made with the contract count (the maximum contract count) i₀, the order specifying unit 254 sets the initial value of the index i=i₀, and repeatedly executes the following process until i=0.

The order specifying unit 254 treats an order of a[i] corresponding to the index i as a contract target. Next, the order specifying unit 254 specifies the quantity α included in auxiliary information set in a[i], and updates the index i by i=i-a. By the order specifying unit 254 repeatedly executing the process until i=0, the sell order as a contract target is specified.

The order specifying unit 254 treats an order of b[i] corresponding to the index i as a contract target. Next, the order specifying unit 254 specifies the quantity α included in auxiliary information set in b[i], and updates the index i by i=i-a. By the order specifying unit 254 repeatedly executing the process until i=0, the buy order as a contract target is specified.

Next, the order specifying unit 254 registers the identification information of the order specified as the contract target by executing the above-described process, in the contract result information 245.

The output control unit 255 is a processing unit that outputs the contract result information 245 to the display unit 230 so as to display the contract result information 245. The output control unit 255 may transmit the contract result information 245 to an external apparatus, and request the external apparatus to execute various contract processes.

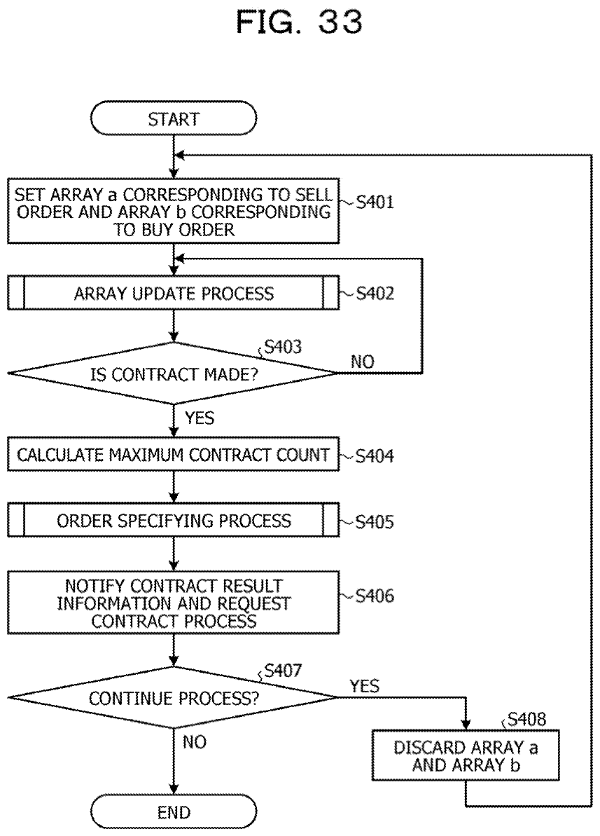

Next, an example of a processing procedure of the information processing apparatus 200 according to Embodiment 2 will be described. FIG. 33 is a flowchart illustrating a processing procedure of the information processing apparatus according to Embodiment 2. As illustrated in FIG. 33, the setting unit 152 of the information processing apparatus 200 sets the array a related to a sell order and the array b related to a buy order (step S401). Information on the array a corresponds to the first array information 243. Information on the array b corresponds to the second array information 244.

The setting unit 252 executes an array update process (step S402). In a case where a contract is not made with this order (No in step S403), the information processing apparatus 200 proceeds to step S402. In a case where the contract is made with this order (Yes in step S403), the information processing apparatus 200 proceeds to step S404.

The contract count calculation unit 253 of the information processing apparatus 200 calculates a maximum contract count (step S404). The order specifying unit 254 of the information processing apparatus 200 executes an order specifying process (step S405).

The output control unit 255 of the information processing apparatus 200 notifies an external apparatus or the like of contract result information, and requests a contract process (step S406). In a case where the process is continued (Yes in step S407), the information processing apparatus 200 proceeds to step S408. The setting unit 252 discards the array a and the array b (step S408), and proceeds to step S401.

In a case where the process is not continued (No in step S407), the information processing apparatus 200 ends the process.

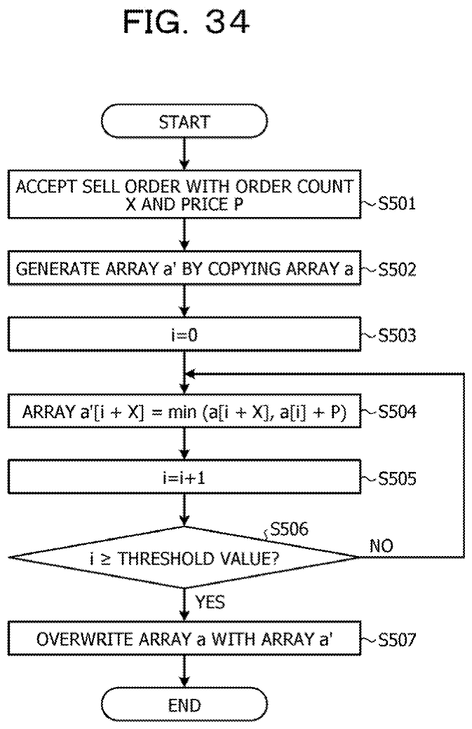

Next, a processing procedure of the array update process described in step S402 in FIG. 33 will be described. FIG. 34 is a flowchart illustrating a processing procedure of an array update process for a sell order according to Embodiment 2. The setting unit 252 of the information processing apparatus 200 accepts a sell order having an order count X and a price P (step S501).

The setting unit 252 generates an array a′ obtained by copying the array a (step S502). The setting unit 252 sets i to an initial value 0 (step S503). By using the array a′[1+X]=min (a[i+X], a[i]+P), the setting unit 252 updates the array a′ (step S504).

By using a value obtained by adding 1 to i, the setting unit 252 updates i (step S505). In a case where i is not equal to or greater than a threshold value (No in step S506), the setting unit 252 proceeds to step S504. By contrast, in a case where i is equal to or greater than the threshold value (Yes in step S506), the setting unit 252 overwrites the array a with the array a′ (step S507).

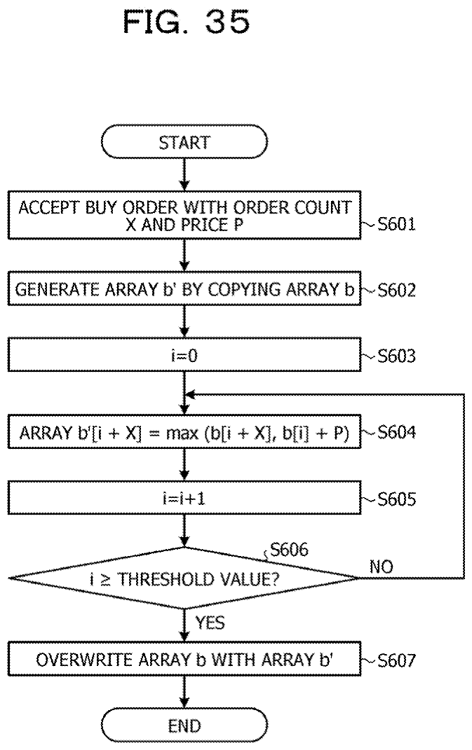

FIG. 35 is a flowchart illustrating a processing procedure of an array update process on a buy order according to Embodiment 2. The setting unit 252 of the information processing apparatus 200 accepts a buy order having the order count X and the price P (step S601).

The setting unit 252 generates an array b′ obtained by copying the array b (step S602). The setting unit 252 sets i to an initial value 0 (step S603). By using the array b′[1+X]=max (b[i+X], b[i]+P), the setting unit 252 updates the array b′ (step S604).

By using a value obtained by adding 1 to i, the setting unit 252 updates i (step S605). In a case where i is not equal to or greater than a threshold value (No in step S606), the setting unit 252 proceeds to step S604. In a case where i is equal to or greater than the threshold value (Yes in step S606), the setting unit 252 overwrites the array b with the array b′ (step S607).

The processing procedure of the order specifying process described in step S406 in FIG. 33 corresponds to the processing procedure described in FIG. 14 according to Embodiment 1.

Next, effects of the information processing apparatus 200 according to Embodiment 2 will be described. As described above, in a case where a sell order is accepted, the information processing apparatus 200 sets information based on an order sequence, an order count, and a price of the sell order to the array a, and in a case where a buy order is accepted, the information processing apparatus according to Embodiment 2 sets information based on an order sequence, an order count, and a price of the buy order to the array b. The information processing apparatus calculates a maximum contract count based on the information set in the array a and the information set in the array b. Based on the calculated maximum contract count, the information set in the array a, and the information set in the array b, the information processing apparatus specifies an order to be a contract target. For example, with the information processing apparatus according to Embodiment 2, it is possible to specify an order to be a contract target that maximizes a contract count while satisfying the conditions (1), (2), and (3).

The information processing apparatus 200 scans the first array information 243 (array a) and the second array information 244 (array b) for each index, and calculates a maximum index i at which a[i] b[i] is satisfied, as a maximum contract amount. Accordingly, it is possible to easily specify the maximum contract count by comparing the array a with the array b. By using the auxiliary information, it is possible to check the indices of the array a and the array b, and specify an order to be a contract target.

### Embodiment 3

Meanwhile, in the information processing apparatus 200 according to Embodiment 2 described above, a sell order is handled as a positive integer in a plus (positive direction), and a minimum value of an order count is calculated and set as the first array a (first array information 243). In the same manner, the information processing apparatus 200 treats a buy order as a positive integer in a plus (positive direction), calculates a maximum value of the order count, and sets the maximum value as the second array a (second array information 244). As described above, in the information processing apparatus 200 according to Embodiment 2, a large calculation cost is desirable for a matching process of specifying an order as a contract target after order statuses of the sell order and the buy order as contract targets are separately handled.

Accordingly, an information processing apparatus according to Embodiment 3 collectively calculates, in one array (third array information 246), the first array a (first array information 243) in which a sell order is handled as a positive integer in a plus (positive direction) and a minimum value of an order count is calculated and set, and the second array a (second array information 244) in which a buy order is handled as a positive integer in a plus (positive direction) and a maximum value of the order count is calculated and set.

For example, for the accepted sell order and buy order, the information processing apparatus according to Embodiment 3 counts an order count in one of the sell order and the buy order (for example, the sell order) as a plus and an order count in the other of the sell order and the buy order (for example, the buy order) as a minus. For an element of one array (third array information 246) specified based on the counted number, the information processing apparatus according to Embodiment 3 sets information based on the accepted sell order and buy order.

For example, in the information processing apparatus according to Embodiment 3, the sell order is handled as a plus and the buy order is handled as a minus, so that the sell order and the buy order may be handled in the same one array. Information to be set for an element is set in the same manner as in the first array in the case of the sell order in Embodiment 2. For example, the information processing apparatus according to Embodiment 3 sets a minimum value of a transaction amount of money in the contract to the element corresponding to the index i of the array (updates when a value of the element decreases).

The information processing apparatus according to Embodiment 3 has substantially the same functional configuration as the functional configuration of Embodiment 2 except that the storage unit 240 stores the third array information 246 related to one array instead of the first array information 243 and the second array information 244.

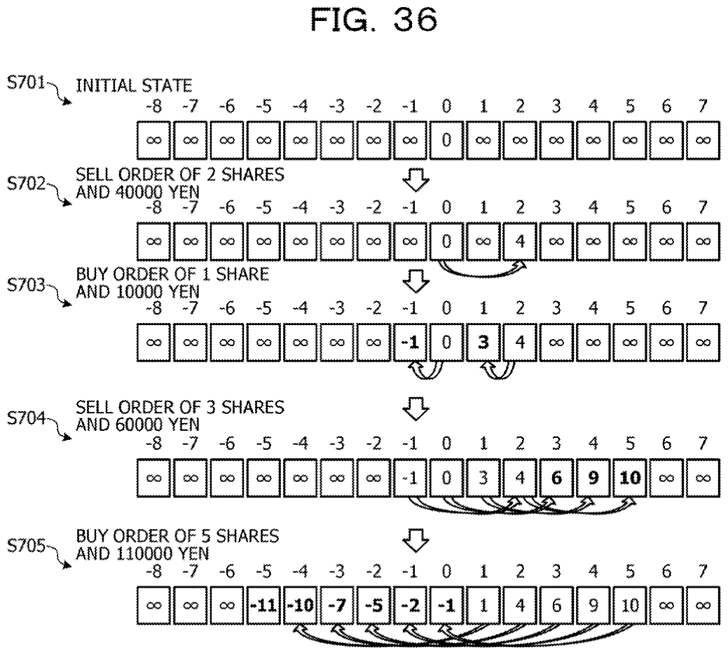

FIG. 36 is a diagram illustrating an example of a data structure of array information according to Embodiment 3. For example, FIG. 36 is a diagram schematically illustrating a structure of one array c related to the third array information 246. A number (index) i of each element in the array c corresponds to an equilibrium position (difference) of an order count in a case where a sell order and a buy order are combined. At an initial state (S701) of the array c, c[0] is 0 (handled as an element of which a value is set to 0), and all other elements are “∞” (handled as an element of which a value is not set).

It is assumed that the acquisition unit 251 accepts a sell order having 2 shares and 40000 yen (S702). At this time, by using the element (c[0]) to which the value is set in the array c as a reference, the setting unit 252 counts 2 shares, which is an order count of the sell order, as a plus and increments the index by 2. When c[i+x]>c[i]+p, the setting unit 252 updates the value of the element as c[i+x]=c[i]+p (updates when the value of the element decreases).

For example, for the element of c[2], the setting unit 252 sets c[2]=4 since c[0+2] (=∞)>c[0]+4 (=4).

Next, it is assumed that the acquisition unit 251 accepts a buy order having one share and 10000 yen (S703). At this time, by using the elements (c[0], c[2]) to which the values are set in the array c as references, the setting unit 252 counts one share, which is an order count of the buy order, as a minus and returns the index by 1. In the same manner as in S702, when c[i+x]>c[i]+p, the setting unit 252 updates the value of the element as c[i+x]=c[i]+p (updates when the value of the element decreases).

For example, for the element of c[−1], the setting unit 252 sets c[−1]=−1 since c[0−1] (=∞)>c[0]−1 (=−1). For the element of c[1], the setting unit 252-sets c[1]=3 since c[2−1] (=∞)>c[2]−1 (=3).

Next, it is assumed that the acquisition unit 251 accepts a sell order having 3 shares and 60000 yen (S704). At this time, by using the elements (c[−1], c[0], c[1], and c[2]) to which the values are set in the array c as references, the setting unit 252 counts 3 shares, which is an order count of the sell order, as a plus and increments the index by 3. In the same manner as in S702, when c[i+x]>c[i]+p, the setting unit 252 updates the value of the element as c[i+x]=c[i]+p (updates when the value of the element decreases).

For example, since c[−1+3] (=4)<c[−1]+6 (=5) is satisfied for the element of c[2], the setting unit 252 sets c[2]=4 (as it is since the value of the element does not decrease). For the element of c[3], the setting unit 252 sets c[3]=6 since c[0+3] (=∞)>c[0]+6 (=6). For the element of c[4], the setting unit 252 sets c[4]=9 since c[1+3] (=∞)>c[1]+6 (=9). For the element of c[5], the setting unit 252 sets c[5]=10 since c[2+3] (=∞)>c[2]+6 (=10).

Next, it is assumed that the acquisition unit 251 accepts a buy order having 5 shares and 110000 yen (S705). At this time, by using the elements (c[−1] to c[5]) to which the values are set in the array c as references, the setting unit 252 counts 5 shares, which is an order count of the buy order, as a minus and returns the index by 5. In the same manner as in S702, when c[i+x]>c[i]+p, the setting unit 252 updates the value of the element as c[i+x]=c[i]+p (updates when the value of the element decreases).

Since the value of c[0] is updated from 0 to −1, the order specifying unit 254 determines that there is a combination in which the order count of the sell order and the order count of the buy order coincide with each other (it is possible to make a contract). As described above, in one array c, the order specifying unit 254 determines whether or not a contract is available based on the information set in the element in which a difference in the order counts is 0. Next, the order specifying unit 254 specifies an order to be a contract target among the sell orders and the buy orders set in one array c (third array information 246). For example, the order specifying unit 254 specifies an order to be a contract target based on auxiliary information indicating a sequence number of an order (identification information of an order) given to each element of one array c in the same manner as in Embodiment 2.

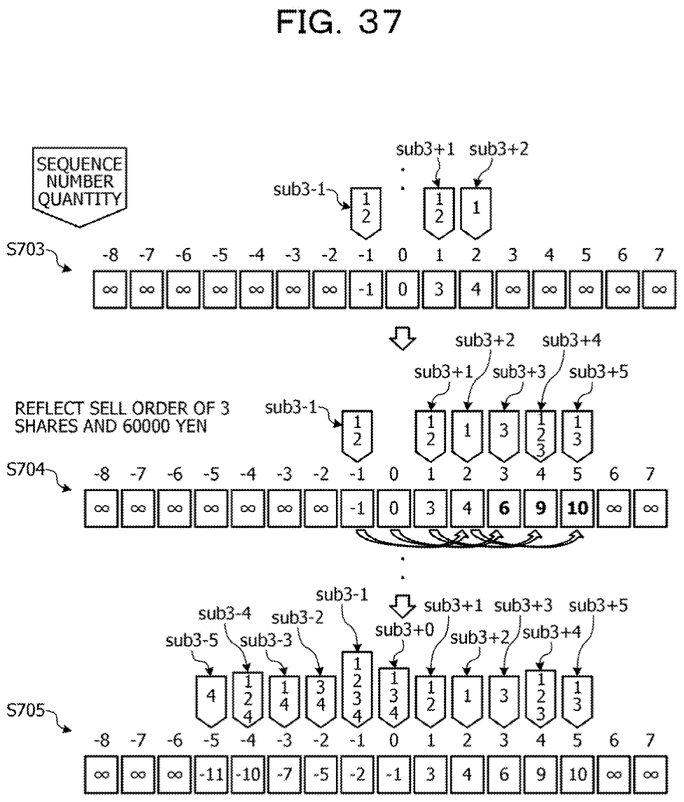

FIG. 37 is a diagram describing a process on an array according to Embodiment 3. For example, FIG. 37 is a diagram describing addition of auxiliary information (sub3) to each element of one array c. A subscript (0, +1, +2, . . . , −1, −2, . . . ) in the auxiliary information sub3 corresponds to a number (index) of the element.

As illustrated in FIG. 37, when an accepted order is set in each element, the setting unit 252 sets identification information (numbers of 1, 2, . . . in the illustrated example) of the order in the auxiliary information sub3 in a reception sequence. For example, when the sell order of 2 shares and 40000 yen is accepted and c[1] is set in S702, the setting unit 252 sets the sell order (1) in the auxiliary information sub3+1 of c[1]. After that, when the buy order (2) of one share and 10000 yen is accepted and c[1] and c[−1] are set in S703, the setting unit 252 sets the sell order (1) and the buy order (2) in the auxiliary information sub3+1 and sub3−1 of c[1] and c[−1].

Even when the sell order (3) of 3 shares and 60000 yen is accepted (S704) and the buy order (4) of 5 shares and 110000 yen is accepted (S705), the setting unit 252 sets the auxiliary information sub3 in each element in the same manner. Accordingly, as illustrated in FIG. 37, auxiliary information sub3−5 to sub3+5 is set in each of c[−5] to c[5]. The auxiliary information sub3−5 to sub3+5 indicates a combination of a sell order and a buy order in a case corresponding to a number of the element (difference in the order counts).

Therefore, when the value of c[0] is updated from 0 to −1 and it is determined that a contract is available, the order specifying unit 254 specifies an order to be a contract target, based on the identification information of the order set in the auxiliary information sub3−0 of c[0]. In the case in FIG. 37, the sell orders (1) and (3) and the buy order (4) are specified as a combination of orders with which a contract is available. As described above, the order specifying unit 254 may easily specify a combination of a sell order and a buy order with which a contract is available, based on the auxiliary information sub3−0 of c[0].

Although the index (the auxiliary information sub3−0, sub3+1, sub3+2, . . . , sub3−1, sub3−2, . . . ) of each element is a list of orders and a memory use amount is increased in a case where the index is held as it is, the index is only added to an end in the process described above. For this reason, index holding may be performed in a memory structure such as a trie (a node of the trie corresponds to an index). For example, it is possible to suppress an increase in memory use amount with the compression of the indices.

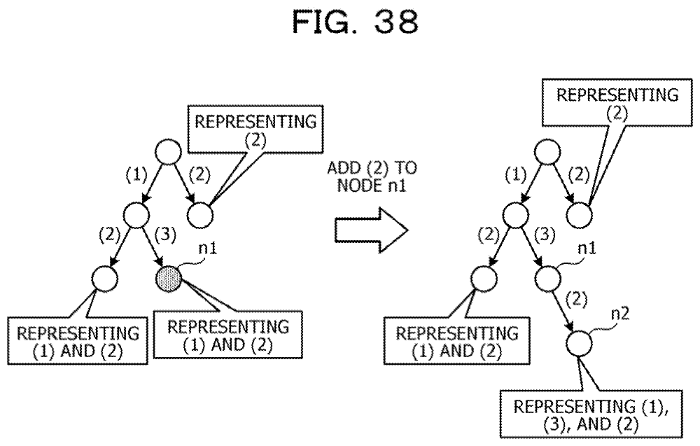

FIG. 38 is an explanatory diagram describing compression of indices. As illustrated in FIG. 38, in a memory structure of an index of each element, it may be said that a node of a trie corresponds to the index. Therefore, in a case where an order number (2) is added to a node n1 in which an order number (1) and an order number (3) are combined, a node n2 of the order numbers (1), (3), and (2) is set.

As described above, for accepted sell orders and buy orders, the information processing apparatus 200 according to Embodiment 3 counts an order count in one of the sell order and the buy order as a plus (the sell order in the embodiment). For the accepted sell orders and buy orders, the information processing apparatus 200 according to Embodiment 3 counts an order count in the other of the sell order and the buy order (the buy order in the embodiment) as a minus. The information processing apparatus 200 according to Embodiment 3 sets information based on the accepted sell order and buy order to an element of one array specified by counting in this manner. Based on the information set in one array, the information processing apparatus 200 according to Embodiment 3 specifies an order to be a contract target among the accepted sell orders and buy orders.

Accordingly, the information processing apparatus 200 according to Embodiment 3 may handle an order status in which the accepted sell order and buy order are combined in one array. For this reason, in the information processing apparatus 200 according to Embodiment 3, it is possible to reduce a calculation cost when making a contract for trading, as compared with a case where the order statuses of the sell order and the buy order are separately handled.

In one array, a difference in the order counts obtained by combining the sell order and the buy order is set as a number of the element. By using an element to which information based on the order is set in one array as a reference, the information processing apparatus 200 according to Embodiment 3 sets the information set in the element as a reference and the information based on the accepted order, to an element specified by counting a number based on the order count of the accepted order. Accordingly, in the information processing apparatus 200 according to Embodiment 3, it is possible to store the order status in which the accepted sell order and buy order are combined in one array having a difference between the order counts obtained by combining the sell order and the buy order as the element number.

The information processing apparatus 200 according to Embodiment 3 specifies an order to be a contract target based on information set in an element in which the difference between the order counts is 0 in one array. Accordingly, the information processing apparatus 200 according to Embodiment 3 may specify an order to be a contract target such that the order counts of the sell order and the buy order are balanced.

It is noted that each component of each apparatus illustrated in the drawings may not be physically configured as illustrated in the drawings. For example, specific forms of the separation and integration of each apparatus are not limited to those illustrated in the drawings. The entirety or part of the apparatus may be configured by functionally or physically separating into arbitrary units or integrating into an arbitrary unit in accordance with various loads, usage situations, and the like.

Although each embodiment described above exemplifies a case to be applied to the case where an order is made under a condition of a total amount contract or a certain order count in stock trading in the securities trading market, the present embodiment is not limited to the application to the stock trading. For example, the present embodiment may be applied to trading other than stock trading, such as futures trading markets.

All or certain some of the various processing functions to be executed by the information processing apparatuses 100 and 200 may be executed by a CPU (or a microcomputer such as an MPU or a micro controller unit (MCU)) or a graphics processing unit (GPU). Of course, all or certain some of the various processing functions may be executed in programs analyzed and executed by the CPU (or a microcomputer such as the MPU or MCU) or the GPU or may be executed in hardware using wired logic. The various processing functions performed in the information processing apparatuses 100 and 200 may be executed in such a way that a plurality of computers cooperate with each other via cloud computing.

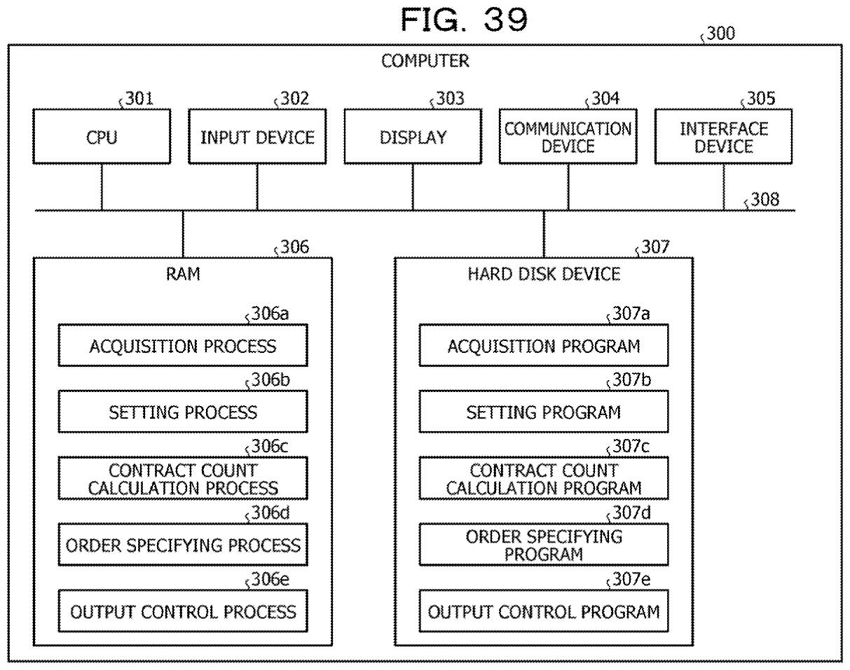

Next, an example of a hardware configuration of a computer that implements functions similar to those of the information processing apparatus 100 (200) described in the above embodiment will be described. FIG. 39 is a diagram illustrating an example of a hardware configuration of a computer that implements a function in the same manner as a function of the information processing apparatus according to the embodiment.

As illustrated in FIG. 39, a computer 300 includes a CPU 301 which executes various operation processes, an input device 302 which accepts input of data from a user, and a display 303. The computer 300 includes a communication device 304 that exchanges data with an external apparatus or the like via a wired or wireless network, and an interface device 305. The computer 300 also includes a RAM 306 that temporarily stores various kinds of information and a hard disk device 307. Each of devices (the CPU 301 to the hard disk device 307) is coupled to a bus 308.

The hard disk device 307 includes an acquisition program 307a, a setting program 307b, a contract count calculation program 307c, an order specifying program 307d, and an output control program 307e. The CPU 301 reads each of the programs 307a to 307e, and expands the program into the RAM 306.

The acquisition program 307a functions as an acquisition process 306a. The setting program 307b functions as a setting process 306b. The contract count calculation program 307c functions as a contract count calculation process 306c. The order specifying program 307d functions as an order specifying process 306d. The output control program 307e functions as an output control process 306e.

A process of the acquisition process 306a corresponds to the processes of the acquisition units 151 and 251. A process of the setting process 306b corresponds to the processes of the setting units 152 and 252. A process of the contract count calculation process 306c corresponds to the processes of the contract count calculation units 153 and 253. A process of the order specifying process 306d corresponds to the processes of the order specifying units 154 and 254. A process of the output control process 306e corresponds to the process of the output control units 155 and 255.

Each of the programs 307a to 307e may not be stored in the hard disk device 307 from the beginning. For example, each program may be stored in a “portable physical medium” such as a flexible disk (FD), a CD-ROM, a DVD, a magneto-optical disk, an IC card, or the like inserted in the computer 300. The computer 300 may read and execute each of the programs 307a to 307e. Each of the programs 307a to 307e may be stored in an external apparatus coupled to a network such as a public line, the Internet, a LAN, or the like, and each of the programs 307a to 307e may be read from the external apparatus coupled to the network and executed by the computer 300.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a contract program causing a computer to execute a process comprising:
setting, for accepted sell order and buy order, information based on the accepted sell order and buy order to an element of one array specified by counting an order count of one order of the sell order and the buy order as a plus, and counting an order count of the other order of the sell order and the buy order as a minus; and
specifying an order to be a contract target among the accepted sell order and buy order, based on the information set in the one array.

2. The non-transitory computer-readable recording medium according to claim 1,
wherein in the one array, a difference in order counts obtained by combining the sell order and the buy order is set as a number of the element, and
in the setting, the element to which information based on the order is set in the one array is used as a reference, the information set in the element used as the reference and the information based on the accepted order are set to the element specified by counting a number based on the order count of the accepted order.

3. The non-transitory computer-readable recording medium according to claim 2,
wherein in the specifying, an order to be a contract target is specified based on information set in the element in which a difference in the order counts is 0.

4. A contract method comprising:
setting, by a computer, for accepted sell order and buy order, information based on the accepted sell order and buy order to an element of one array specified by counting an order count of one order of the sell order and the buy order as a plus, and counting an order count of the other order of the sell order and the buy order as a minus; and
specifying an order to be a contract target among the accepted sell order and buy order, based on the information set in the one array.

5. The contract method according to claim 4,
wherein in the one array, a difference in order counts obtained by combining the sell order and the buy order is set as a number of the element, and
in the setting, the element to which information based on the order is set in the one array is used as a reference, the information set in the element used as the reference and the information based on the accepted order are set to the element specified by counting a number based on the order count of the accepted order.

6. The contract method according to claim 5,
wherein in the specifying, an order to be a contract target is specified based on information set in the element in which a difference in the order counts is 0.

7. An information processing apparatus comprising:
a memory; and
a processor coupled to the memory and configured to:
set, for accepted sell order and buy order, information based on the accepted sell order and buy order to an element of one array specified by counting an order count of one order of the sell order and the buy order as a plus, and counting an order count of the other order of the sell order and the buy order as a minus; and
specify an order to be a contract target among the accepted sell order and buy order, based on the information set in the one array.

8. The information processing apparatus according to claim 7,
wherein in the one array, a difference in order counts obtained by combining the sell order and the buy order is set as a number of the element, and
the element to which information based on the order is set in the one array is used as a reference, and the information set in the element used as the reference and the information based on the accepted order are set to the element specified by counting a number based on the order count of the accepted order.

9. The information processing apparatus according to claim 8,
wherein an order to be a contract target is specified based on information set in the element in which a difference in the order counts is 0.
